(19) United States
(12) Patent Application Publication
(10) Pub. No.: US 2010/0077311 A1
(43) Pub. Date: Mar. 25, 2010

(54) METHOD AND APPARATUS FOR NAVIGATING A GRAPHICAL REPRESENTATION OF A VIRTUAL EXHIBITION

(75) Inventors: Lucio Santoro, London (GB); Julian Madle, Kings Lynn (GB); Harvey Gilpin, Petworth (GB)

Correspondence Address: CONLEY ROSE, P.C.;David A. Rose, P. O. BOX 3267, HOUSTON, TX, 77253-3267, US

(73) Assignees: Lucio SANTORO, London (UK); Meera SANTORO, London (UK)

(21) Appl. No.: 12/527,912

(22) PCT Filed: Feb. 23, 2007
(86) PCT No.: PCT/GB2007/000622

§ 371 Date: Aug. 20, 2009

(51) Int. Cl. G06F 3/00

(52) U.S. Cl. 715/738

(57) ABSTRACT

Various techniques of relevance in providing virtual exhibitions using a computer system are described. One aspect of the invention provides a method for displaying a graphical representation of a scene in a computer system. The method comprises displaying a first graphical representation of said scene; receiving user input identifying graphical data to be applied to at least one of a plurality of surfaces of said scene; and displaying a second graphical representation of said scene in which said graphical data is applied to said at least one of said plurality of surfaces.

The present invention relates to methods and apparatus for providing virtual exhibitions, as well as to various techniques which can be used particularly but not exclusively in such exhibitions, including techniques for processing graphical data, and techniques for storing and processing hierarchical data.

Exhibitions and trade shows are well known. Such exhibitions and trade shows typically comprise a plurality of exhibitors each of whom has an exhibition space at which they display their products and/or advertise their services. Such exhibitions typically take place in an appropriate exhibition space. When sufficiently large, exhibitions are often divided between a plurality of exhibition halls. These halls typically take the form of large open rooms. Exhibition booths are placed within the rooms to create an environment conducive for exhibitors to display what they have to offer and for visitors to peruse what is on offer.

Exhibitions of this sort take a wide variety of different forms. Some are open to the public, while others are restricted to members of a particular trade or profession. They are often held at regular intervals. For example some countries hold an annual motor show at which major motor manufacturers exhibit their latest vehicles.

Computers are ubiquitous in modern society. They are now used for a wide variety of applications in home and business environments. Many computers are now connected together allowing users to communicate with one another and allowing data to be shared between computers. Many computers are connected to a global network known as the Internet allowing a variety of functions to be provided. For example, users with web browser software can access web pages which are provided by web servers making up the worldwide web.

Various attempts have been made to provide virtual exhibitions. These are exhibitions or trade shows of the type described above which are, in some way or other, accessed using a computer. Such exhibitions can be accessed over the Internet. For various reasons, these attempts have not enjoyed widespread success. For example some systems providing virtual exhibitions require a user to download an application including both a user interface and data defining the virtual exhibition. Such an approach is disadvantageous given that it is inherently inflexible and unable to easily allow changes to an exhibition's content. For example, if a single exhibitor's exhibition space is updated, the entire application must be downloaded. This gives rise to another inherent disadvantage in that large quantities of data need to be received to allow the exhibition to be viewed. This is particularly problematic where virtual exhibitions are provided over the Internet, and especially so where users connect to the Internet using relatively slow so-called “dial up” connections.

Furthermore, the approach provided in the prior art requires that a separate application is provided for each virtual exhibition. This exacerbates the problems outlined above.

It is an object of embodiments of the present invention to obviate or mitigate at least some of the problems outlined above.

According to a first aspect of the present invention, there is provided a method for displaying a graphical representation of a scene in a computer system. The method comprises displaying a first graphical representation of said scene, receiving user input identifying graphical data to be applied to at least one of a plurality of surfaces of said scene, and displaying a second graphical representation of said scene in which said graphical data is applied to said at least one of said plurality of surfaces.

In this way, the first aspect of the present invention provides an interactive way of customizing a scene, allowing a first representation to be viewed, allowing customization in terms of graphical data to be applied to the scene to be specified, and then allowing a second representation to be viewed.

Each of said plurality of surfaces may have an associated identifier, and at least two of the plurality of surfaces may have the same associated identifier.

The first graphical representation of said scene may display identifiers associated with each of said plurality of surfaces. For example, respective identifiers can be displayed on the surfaces for ease of identification.

The user input identifying graphical data to be applied to said at least one of said plurality of surfaces may identify a file storing said graphical data. For example a user may input a filename or file path of a file storing the appropriate graphical data.

User input may be received using an appropriate user interface, preferably a graphical user interface. The user interface may be configured to receive an identifier of said at least one of said plurality of surfaces to which said graphical data is to be applied. This can be achieved in any convenient way. For example, the user interface may be configured to display a user selectable list of identifiers associated with surfaces in said scene. Receiving user input can then comprise receiving selection of an identifier from the user selectable list of identifiers and receiving user input identifying graphical data to be associated with surfaces associated with said selected identifier.

The method may further comprise receiving user input identifying navigation data to be associated with at least one of said plurality of surface, and storing said navigation data in association with said at least one of said plurality of surfaces. The navigation data may be a hyperlink targeting a predetermined uniform resource locator (URL). In this way, a scene is provided in which particular surfaces are associated with particular navigation data, such that surfaces can be selected by a user to cause the navigation data to be executed. For example, where the navigation data is a URL, selection of a surface may cause data associated with the URL to be displayed in a web browser. Navigation data can be specified in any convenient way, for example user input identifying navigation data to be associated with surfaces associated with a selected identifier from the list of identifiers may be received.

Displaying the first graphical representation of said scene may comprise receiving data defining said scene from a remote server, and processing that received data. The received data may identify a plurality of data items required to display said first representation of said scene. The method may comprise processing said data identifying said plurality of data items required to display said first representation of said scene to determine whether each of said plurality of data items is available locally. If one of the plurality of data items is available locally the data item may be obtained from local storage. If one of the plurality of data items is not available locally the data item may be downloaded from a remote server.

Obtaining a data item from local storage may involve various processing to determine whether a version of the data item stored in local storage is up to date. This processing may comprise determining a first parameter value associated with the data item specified in the received data, processing the data item obtained from local storage to determine a second parameter value, comparing said first and second parameter values, and if said comparing indicates that said first and second parameter values do not satisfy a predetermined criterion, downloading said data item from a remote server. The parameter values may be values of a checksum.

Each of the data items may be a file. At least one of the data items preferably comprises a three dimensional definition of said scene, while at least one of the data items preferably comprises graphical data to be applied to a surface in said scene.

The data identifying a plurality of data items required to display said first representation of said scene is defined by a file of predetermined format, for example XML format.

The method may further comprise uploading said data identifying graphical data to be applied to said at least one of said plurality of surfaces of said scene to a remote server. Displaying the second graphical representation of the scene may comprise receiving data defining said scene from a remote server, said data including reference to said graphical data to be applied to said at least one of said plurality of surfaces. The data defining said scene may comprise data identifying a plurality of data items required to display said second representation of said scene.

The method may further comprise providing a user interface, said user interface being configured to allow a user navigate around at least one of said first graphical representation of said scene and said second representation of said scene. Preferably the user interface is configured to allow the user to navigate around both first and second graphical representations of said scene.

The scene may be part of a virtual exhibition. More particularly, the scene may comprise an exhibition space such as an exhibition booth which is associated with a particular exhibitor. In this way a convenient mechanism of allowing customization of an exhibition space is provided. In particular, the first representation of the scene may include a plurality of slots (each being a surface to which an image can be applied) having associated identifiers. An exhibitor can then specify images to be associated with those slots, and see the effect of applying an image to each slot when the second graphical representation of the scene is displayed.

The invention further provides a method for creating a graphical representation of an exhibition booth for inclusion in a virtual exhibition. The method comprises displaying a first graphical representation of said exhibition booth, receiving user input identifying graphical data to be applied to at least one of a plurality of surfaces of said exhibition booth, and displaying a second graphical representation of said exhibition booth in which said graphical data is applied to said at least one of said plurality of surfaces.

According to a second aspect of the present invention, there is provided a method for generating a graphical representation of a scene in a computer system. The method comprises determining a plurality of data items required to generate said graphical representation of said scene; for each of said data items, determining a point in said scene associated with the data item; determining a view point position in said scene; processing said points associated with said data items and said view point to generate data indicating an order in which said data items should be processed; and processing said data items in said order.

In this way data items may be processed in a predetermined order based upon their position in a scene and a current view point position, the view point position representing the point from which the scene is viewed. The view point is also referred to herein as a camera position.

Each of the data items may be an image to be applied to a surface in said scene. The point associated with each data item may be a midpoint of a surface to which said image is to be applied. The order may be based upon a prominence of said data items in said scene based upon said view point.

Each of the data items may be stored at a remote server, and the data items may be downloaded in said order. This means that delays in downloading data from the remote server are effectively managed, with reference to the current view point and points associated with the data items to be downloaded.

The processing to generate said order may take into account a distance between said view point and said points associated with said data items. The processing to generate data indicating said order may take into account an angle between a view vector and vectors between said view point and each of said points associated with said data items. In this context the term “view vector” is used to indicate a vector indicating a direction in which the camera is facing. It will be appreciated that processing of this type can be achieved by appropriate vector mathematics.

The method may further comprise displaying an alternative data item pending processing of a data item associated with a point in said scene.

The view point may move. For example a user may wish to navigate around a scene so as to view the scene from different positions, thus causing a change of view point. In such a case, the processing described above may be deferred until said view point is stationary.

The scene may represent a virtual exhibition. The virtual exhibition may comprise a plurality of booths, and at least some of said data items may be associated with said booths. The data items may be advertising images associated with said booths.

The invention further provides a method for generating a graphical representation of a scene in a computer system. The method comprises determining a plurality of data items to be downloaded from a remote data source to generate said scene; for each of said data items, determining a point in said scene associated with the data item; determining a view point position in said scene; processing said points associated with said data items and said view point to generate data indicating an order in which said data items should be downloaded; and downloading said data items from said remote data source in said order.

According to a third aspect of the present invention, there is provided a method of hierarchically storing data defining a scene to be displayed graphically in a computer system. The method comprises storing in a first file details of a plurality of objects in said scene, and storing in respective second files data relating to each of said objects. The first file references each of the second files, and said first file and each of said second files reference further files comprising graphical data defining said scene.

In this way a convenient hierarchical storage system is provided. The first and second files may be files of any suitable format. They may be XML files which define appropriate characteristics of the scene and its objects.

The first file may reference a file comprising graphical data defining said scene, and each of said second files may reference a file comprising graphical data defining parts of said scene. Files comprising graphical data may be of any suitable format. For example files of file type “.3DS” which can be processed using a renderer such as DirectX may be used.

The first file may comprise data defining parameters associated with each of said objects. The parameters may comprise a location of each object in said scene. The first file may comprise checksum data for at least one referenced file. Each of said second files may reference a plurality of image files associated with a respective object.

A third file may reference a plurality of first files so as to provide a mechanism for linking scenes.

The scene may be at least part of a virtual exhibition. The scene may be a hall in said virtual exhibition. Each object may be an exhibition space in said virtual exhibition, such as an exhibition booth.

According to a fourth aspect of the present invention, there is provided a method of providing a plurality of virtual exhibitions in a computer system. The method comprises storing data defining said plurality of virtual exhibitions, providing a first user interface, said first user interface being configured to receive user input comprising requests to exhibit at a specified one of said virtual exhibitions, and providing a second user interface, said second user interface being configured to receive user input comprising requests to view a specified one of said virtual exhibitions.

In this way an integrated system can be provided in which exhibitors can exhibit at, and visitors can visit a plurality of exhibitions. Reference to first and second user interfaces herein is not intended to be limiting. That is, the first user interface is any means by which an exhibitor interacts with the system. This may include graphical user interfaces provided by one or more applications. All or part of the first user interface may be provided by means of web pages which are displayed in a web browser. Similarly, the second user interface is any means by which a visitor interacts with the system. This may include graphical user interfaces provided by one or more applications. All or part of the second user interface may be provided by means of web pages which are displayed in a web browser.

The first user interface may receive registration details from an exhibitor, and may establish an exhibitor account based upon said registration details.

The first user interface may present details of a plurality of virtual exhibitions to a user and receive user selection of one of said plurality of virtual exhibitions. The method may comprise storing a plurality of exhibition space definitions; and receiving user input specifying one of said exhibition space definitions.

The first user interface may allow an exhibitor to configure an exhibition space. This can be achieved in any convenient way. For example, the user interface may allow said exhibitor to interactively configure said exhibition space. The first user interface may allow said user to specify images to be included in said exhibition space, and may provide a graphical display of said exhibition space. This may comprise providing a first graphical display of said exhibition space before application of said images, and providing a second graphical display of said exhibition space after application of said images. Methods according to the first aspect of the present invention can be used to configure an exhibition space.

The second user interface may receive registration details from a visitor, and may establish a visitor account based upon said registration details. The second user interface may present a plurality of exhibitions which are available to visit and receive user selection of one of the plurality of exhibitions. A ticket may be issued to a visitor based upon said registration details and said user selection of one of the plurality of exhibitions.

The method may further comprise displaying a list of virtual exhibitions to which a visitor holds a ticket, receiving user selection of one of the virtual exhibitions to which the visitor holds a ticket, and displaying graphical data associated with the selected exhibition.

The invention further provides a method of providing a plurality of virtual exhibitions. The method comprises storing data defining each of said plurality of virtual exhibitions, each virtual exhibition having associated graphical data; storing data defining each of a plurality of users; receiving a user request, said request identifying one of said plurality of users, and indicating one of said plurality of virtual exhibitions; in response to said user request, generating a ticket, said ticket being associated with said one of said plurality of users and said one of said virtual exhibitions; and restricting access to each of said virtual exhibitions to users having tickets associated with the respective virtual exhibition.

The request may be received via a web browser. Virtual exhibitions may be accessed using a client application which is separate from said web browser.

All aspects of the present invention can be implemented in any convenient form including by way of methods or apparatus. In particular, aspects of the present invention can be implemented by appropriate computer programs which may be stored on tangible or intangible carrier media such as storage devices and communications lines. Suitably programmed computers can also be used implement embodiments of the invention.

Accordingly, the invention further provides a computer readable medium carrying computer readable configured to control a computer to carry out a method as described above. A computer apparatus comprising a memory storing processor readable instructions, and a processor configured to read and execute instructions stored in said memory, wherein said processor readable instructions comprise instructions controlling said processor to carry out a method as described above is also provided.

Embodiments of the present invention will now be described, by way of example, with reference to the accompanying drawings in which:

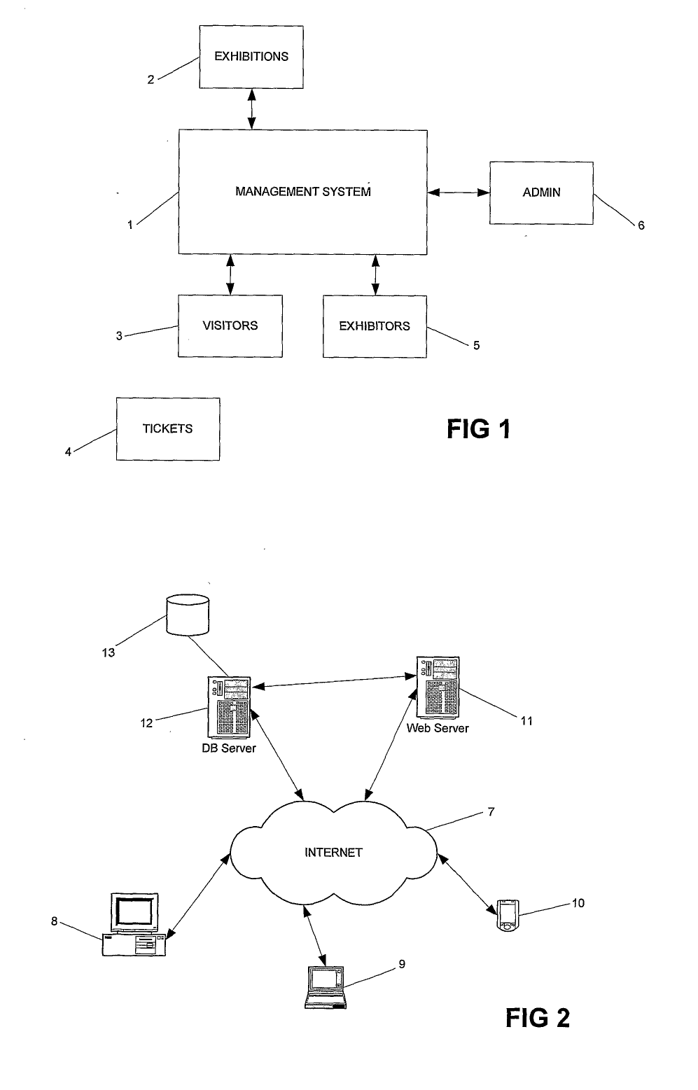

FIG. 1 is a schematic illustration of a virtual exhibition management system provided in an embodiment of the present invention;

FIG. 2 is a schematic illustration of a network of computers suitable for implementing the virtual exhibition management system of FIG. 1;

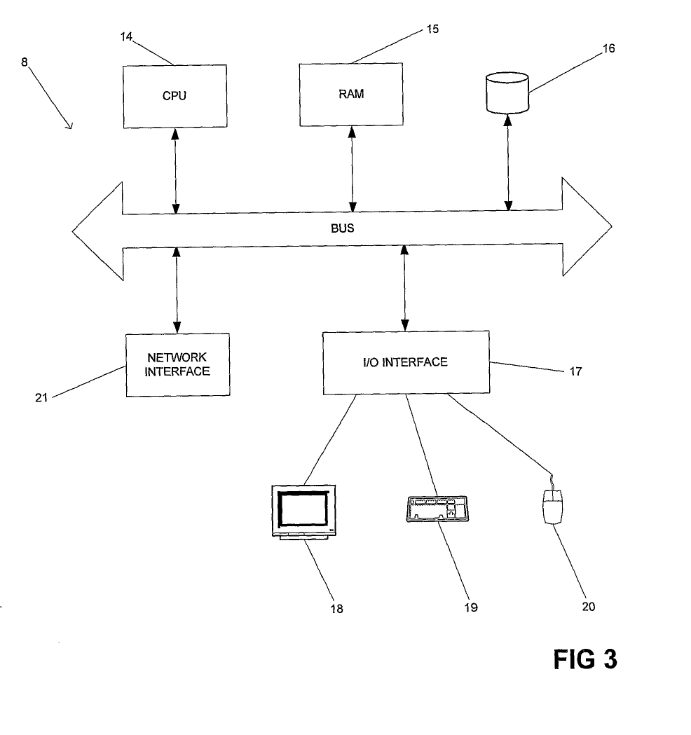

FIG. 3 is a schematic illustration of a desktop PC connected to the network of FIG. 2;

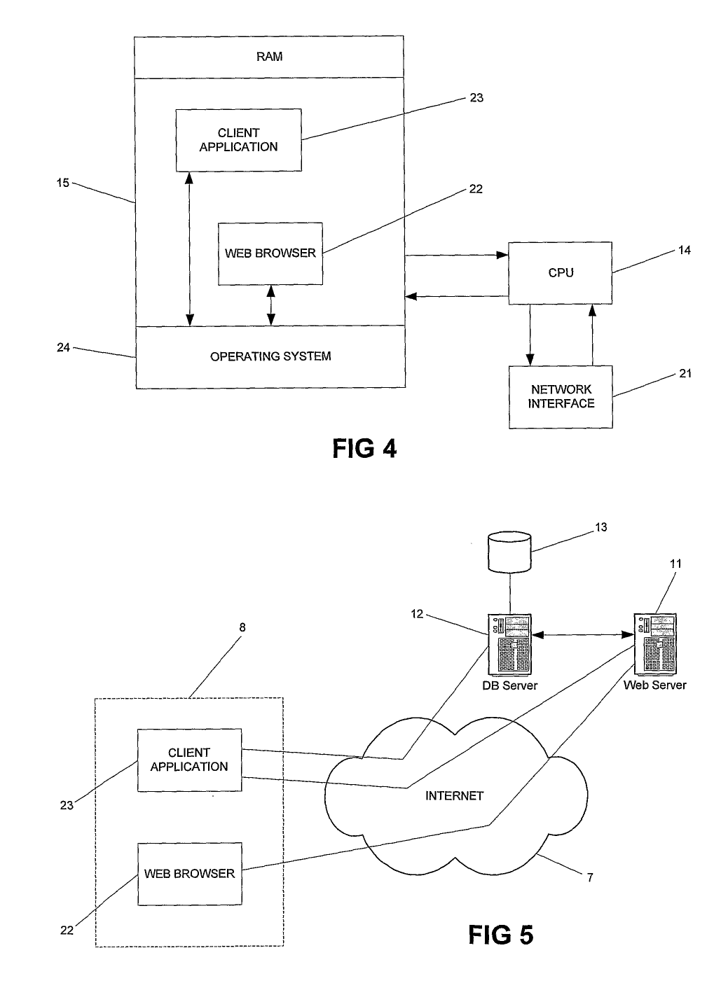

FIG. 4 is a schematic illustration showing components used to implement an embodiment of the present invention;

FIG. 5 is a schematic illustration showing how the components shown in FIG. 4 are used to transfer data over the network of FIG. 2;

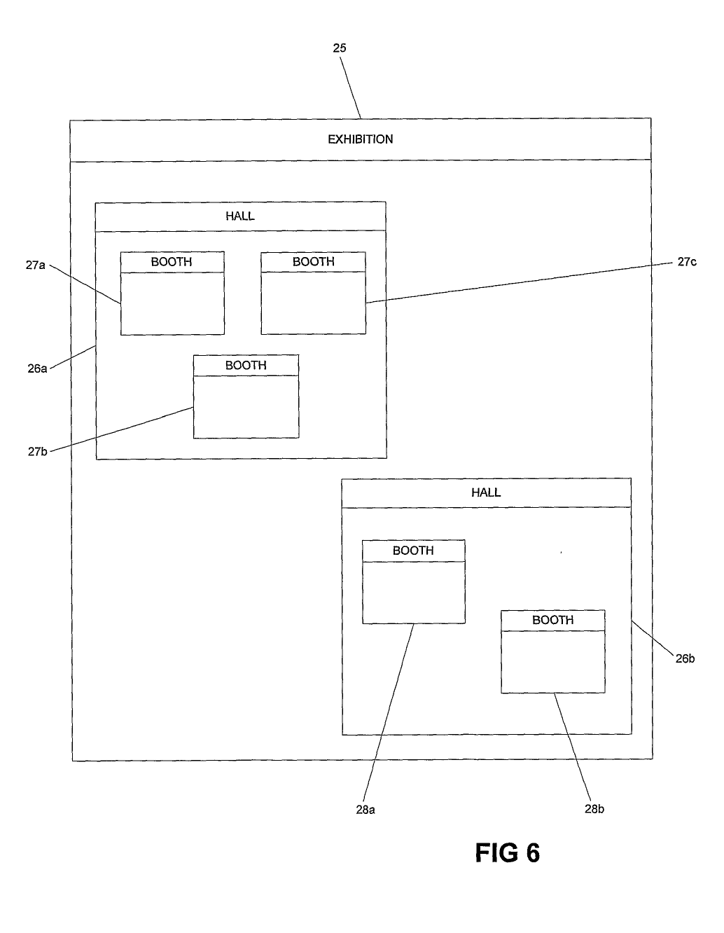

FIG. 6 is a schematic illustration showing a data representation used in an embodiment of the present invention;

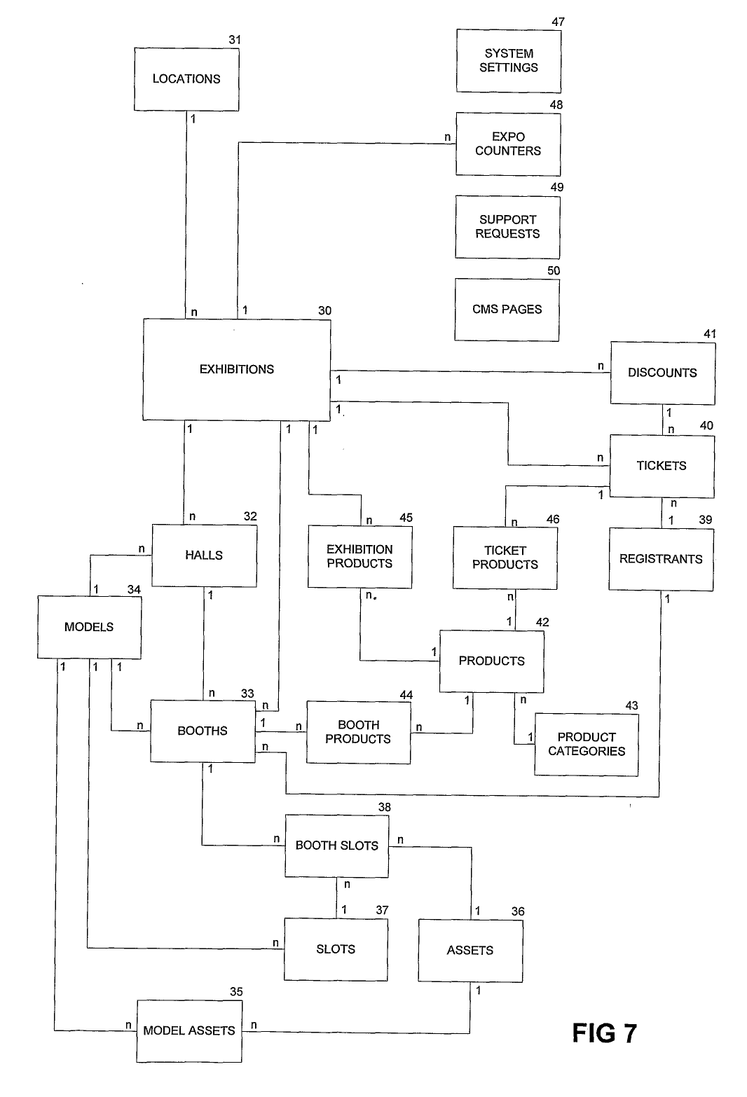

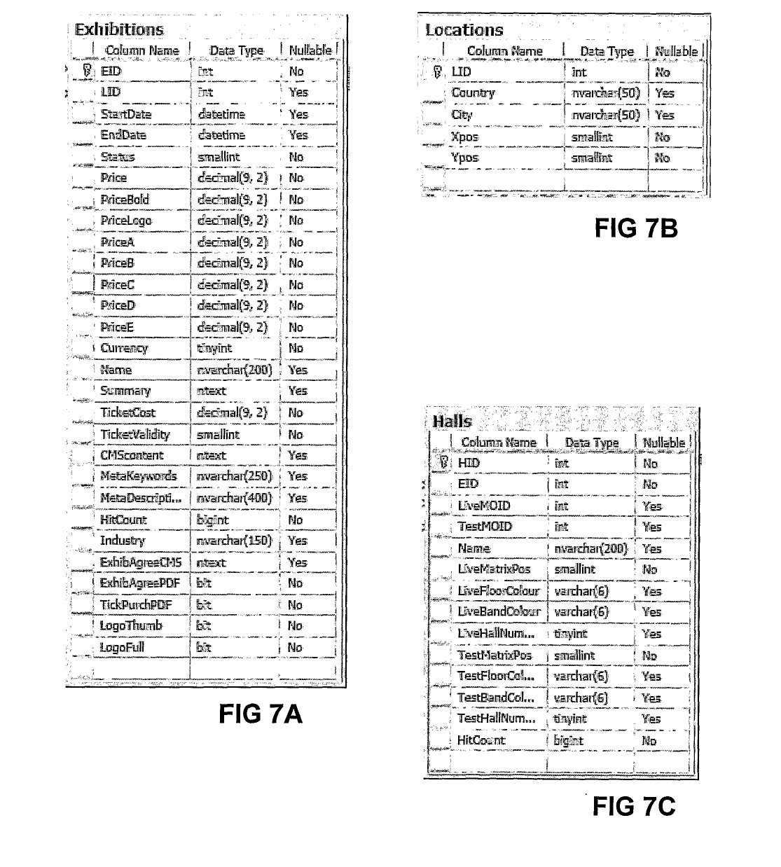

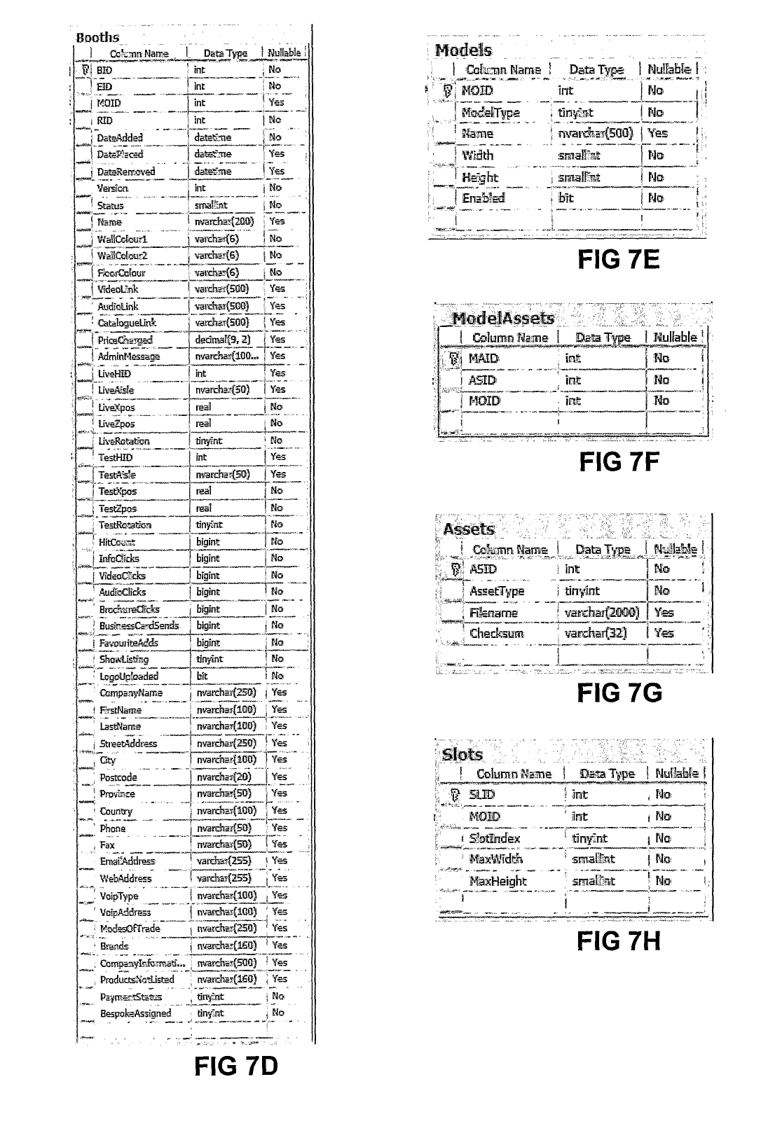

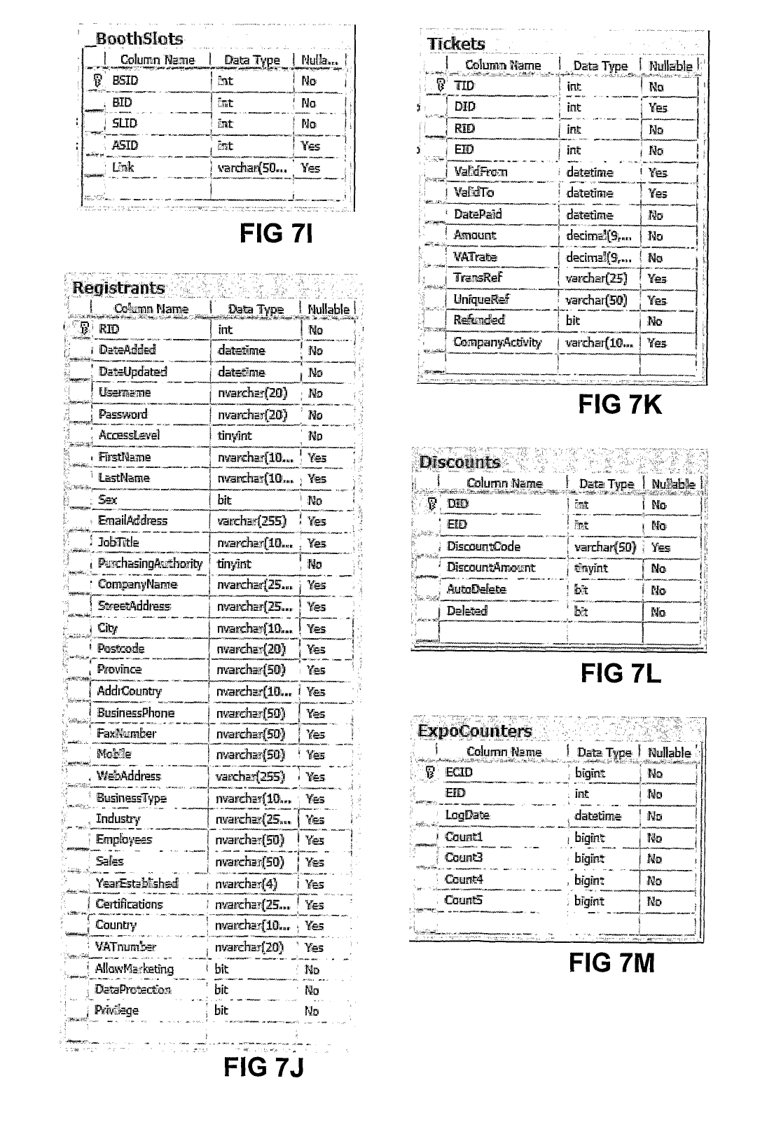

FIG. 7 is an entity relationship diagram showing the structure of data stored in the database of FIG. 2;

FIGS. 7A to 7M are illustrations of tables of the database of FIG. 7;

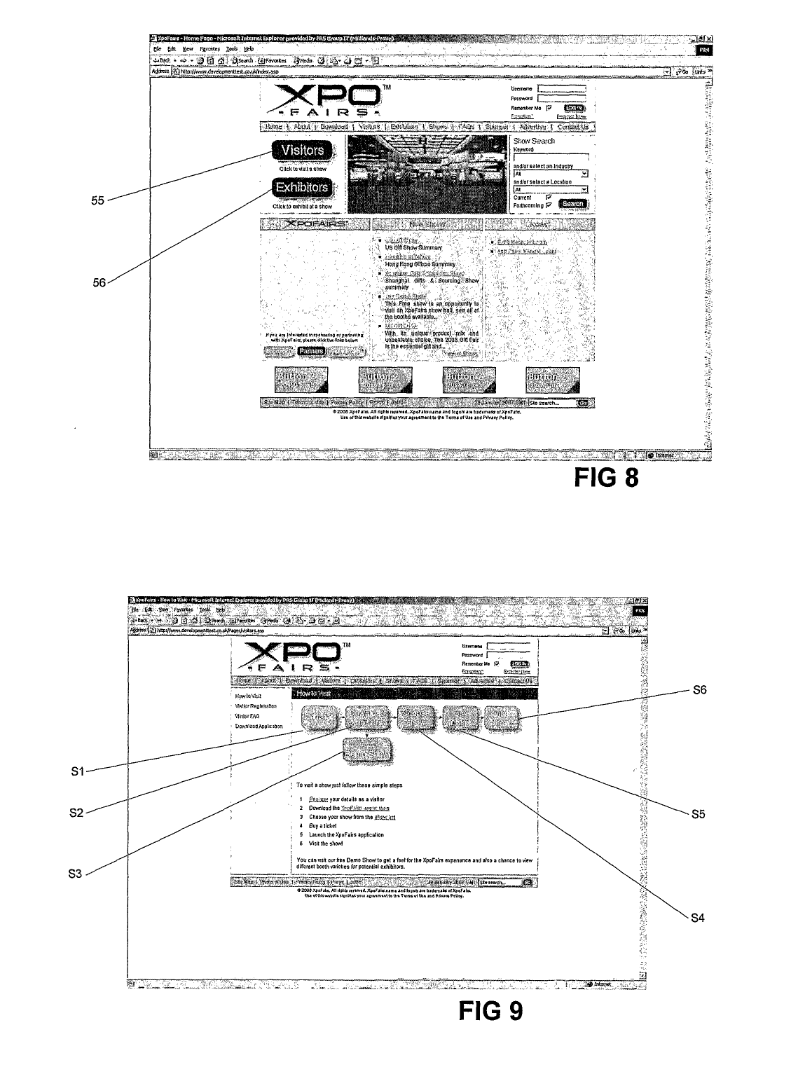

FIG. 8 is a screenshot showing a homepage provided in an embodiment of the present invention;

FIG. 9 is a screenshot showing a webpage providing a user with an overview of a process by which a visitor can visit a virtual exhibition;

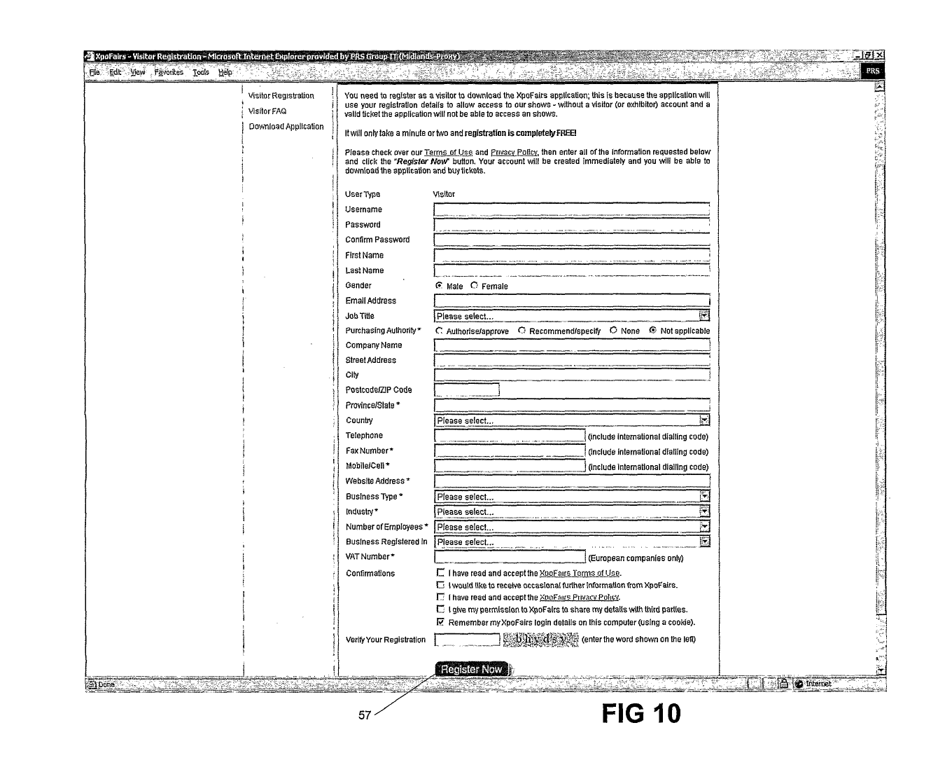

FIG. 10 is a screenshot showing a webpage configured to receive user registration details;

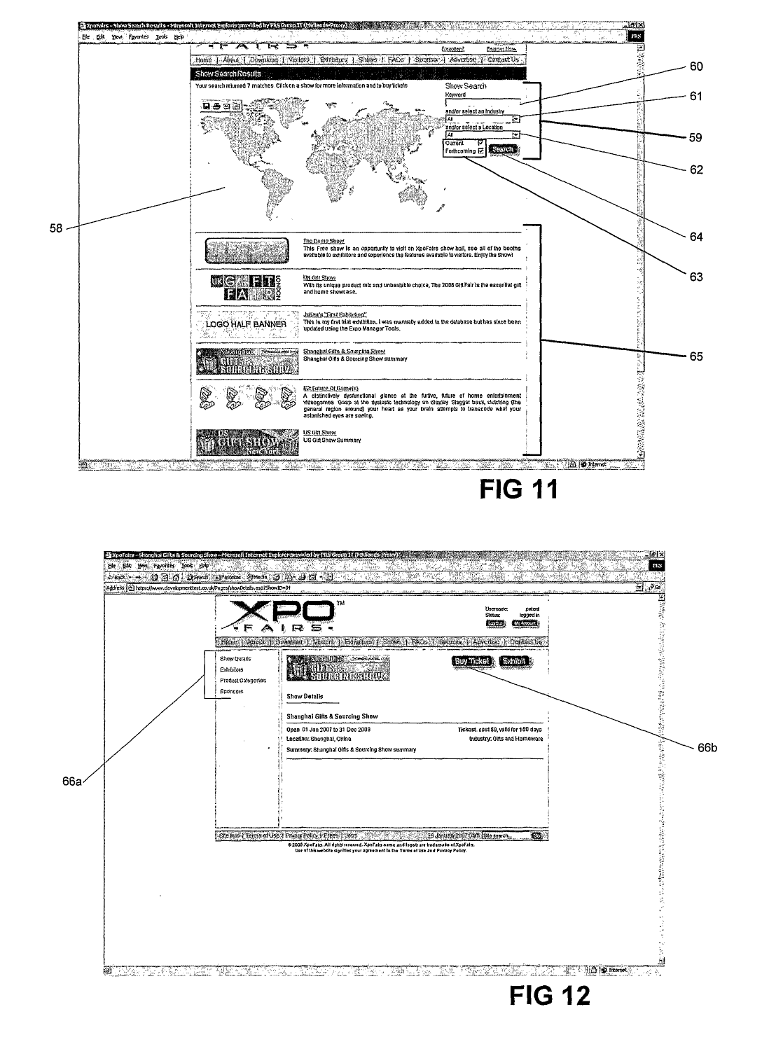

FIG. 11 is a screenshot showing details of a plurality of virtual exhibitions which a user is able to visit;

FIGS. 12 to 14 are screenshots of webpages used to purchase tickets associated with virtual exhibitions;

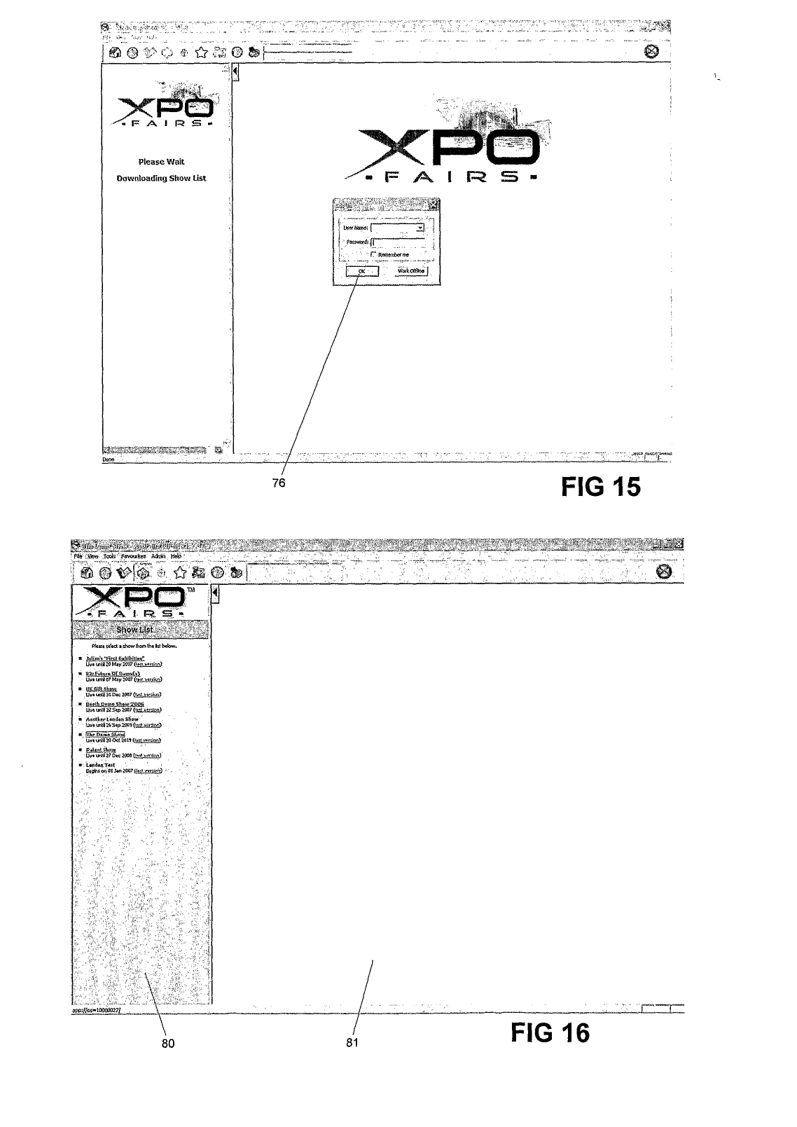

FIG. 15 is a screenshot from a client application used in an embodiment of the invention, showing a log in dialog;

FIG. 16 is a screenshot from the client application showing a list of shows from which a user can select;

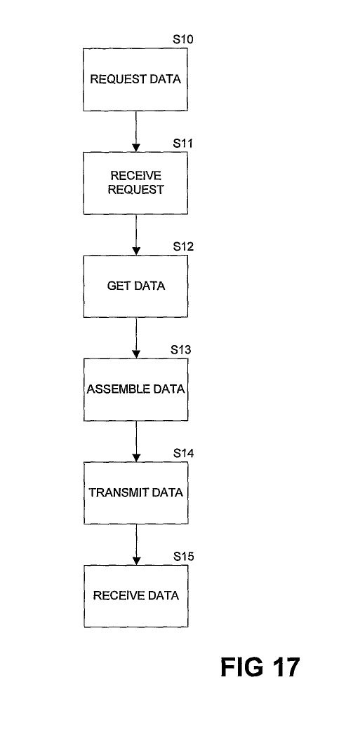

FIG. 17 is a flowchart of processing carried out in the present invention to request and receive appropriate data;

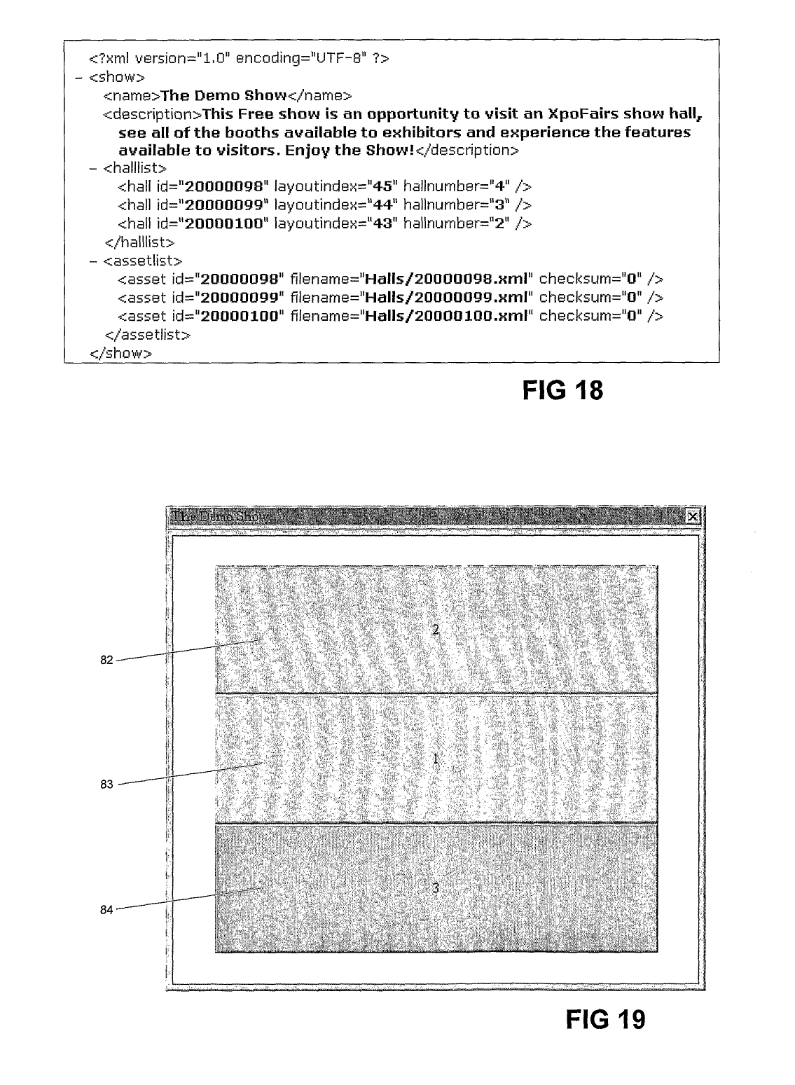

FIG. 18 is an extract from XML file defining a virtual exhibition;

FIG. 19 is a screenshot of a hall map defined by the XML file of FIG. 18;

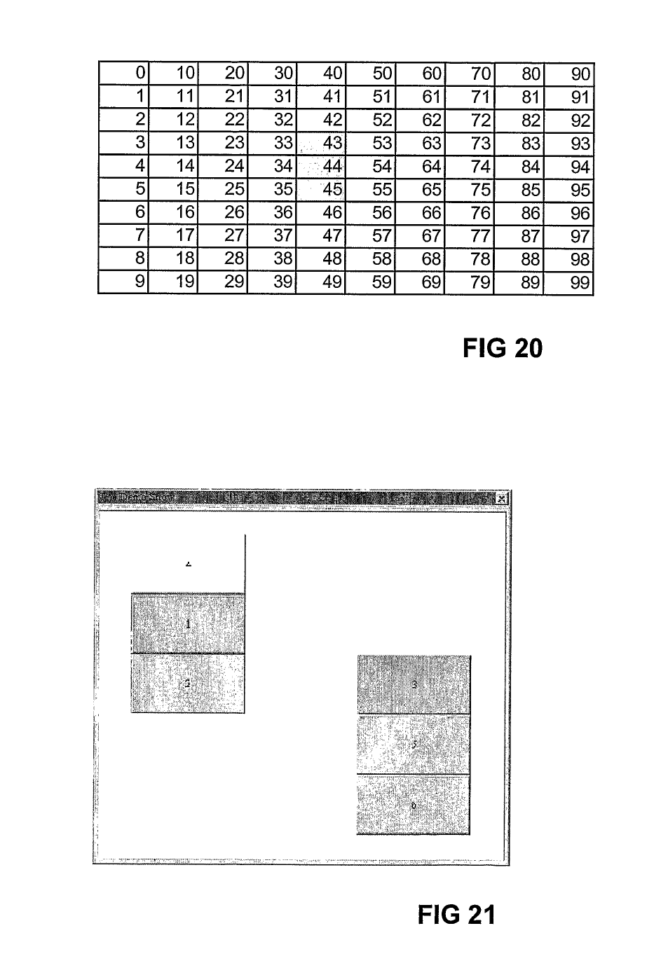

FIG. 20 is an illustration of a grid used in the generation of the hall map of FIG. 19;

FIG. 21 is a screenshot of an alternative hall map to that shown in FIG. 19;

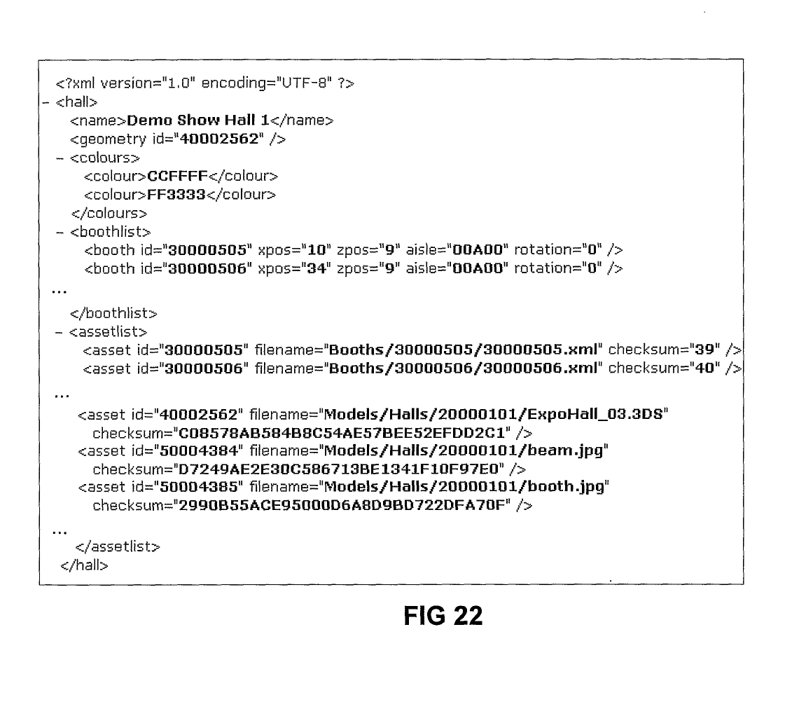

FIG. 22 is an extract from an XML file defining a hall in a virtual exhibition;

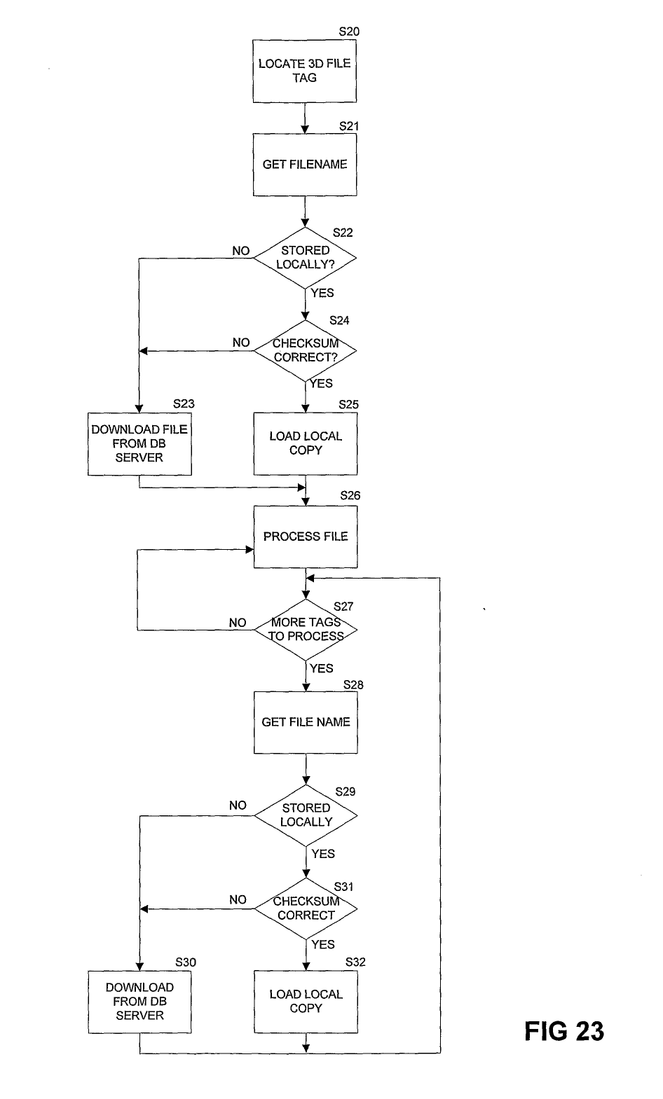

FIG. 23 is a flowchart showing how the XML file of FIG. 22 is processed;

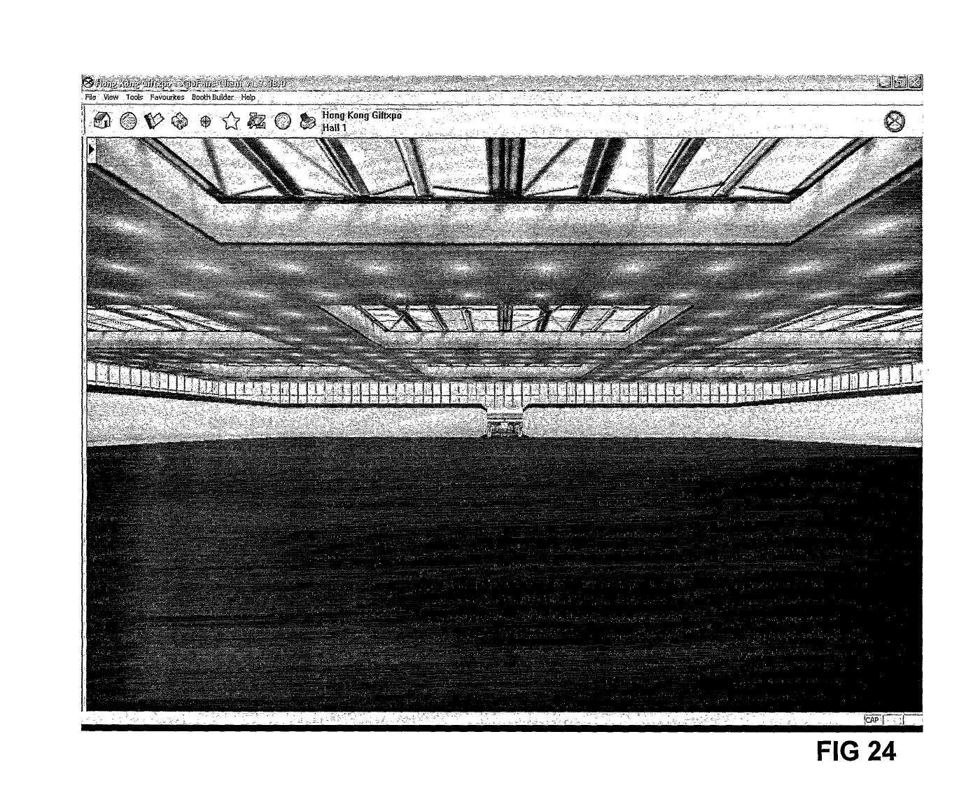

FIG. 24 is screenshot showing a hall included in a virtual exhibition;

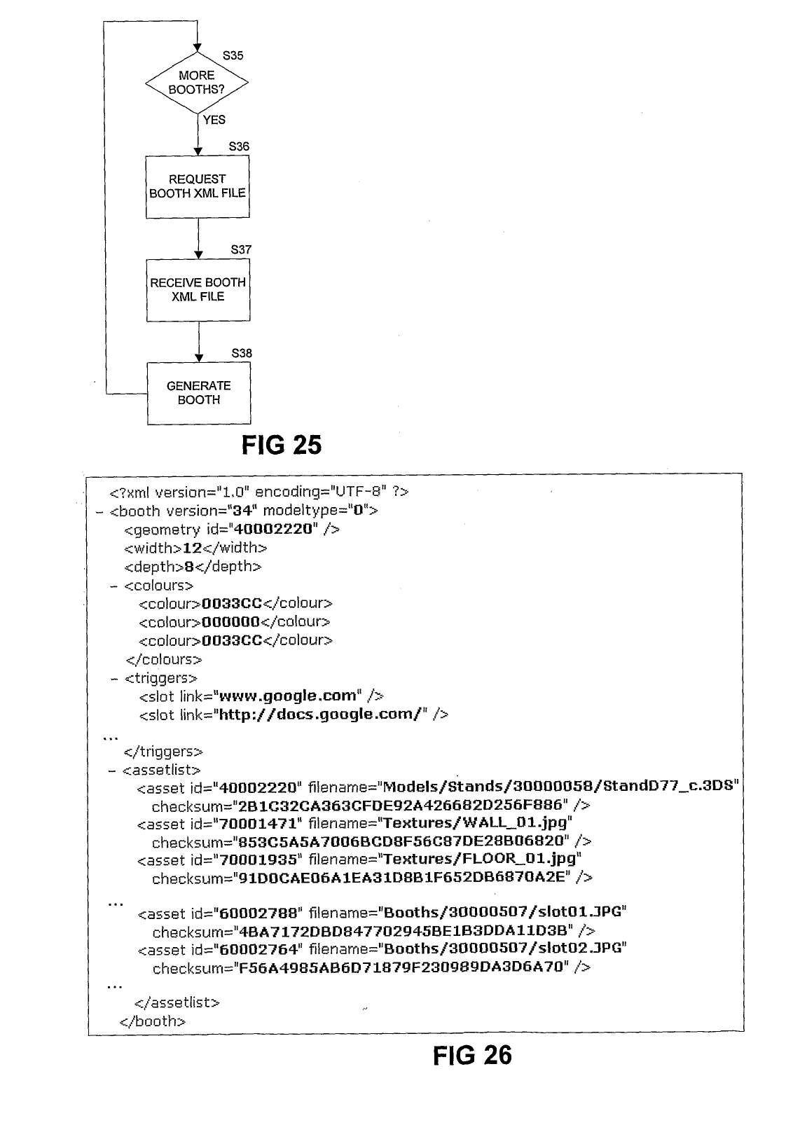

FIG. 25 is a flowchart showing further processing carried out using the XML file of FIG. 22;

FIG. 26 is an extract from an XML file defining a booth within a hall of a virtual exhibition;

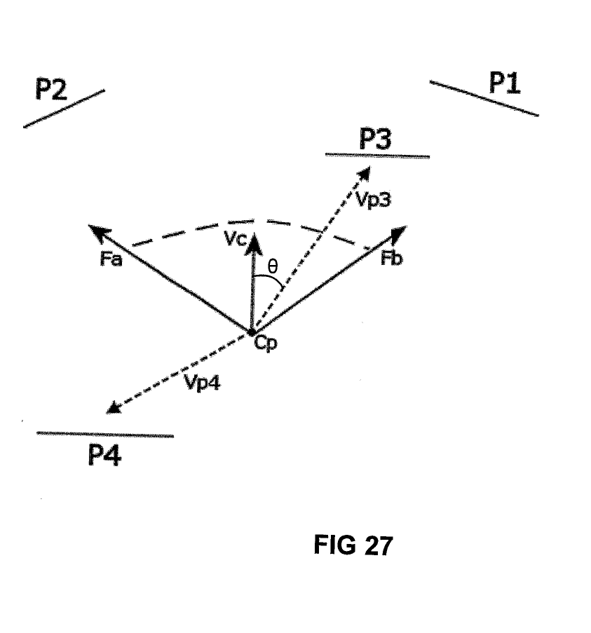

FIG. 27 is a schematic illustration of images within a three dimensional scene;

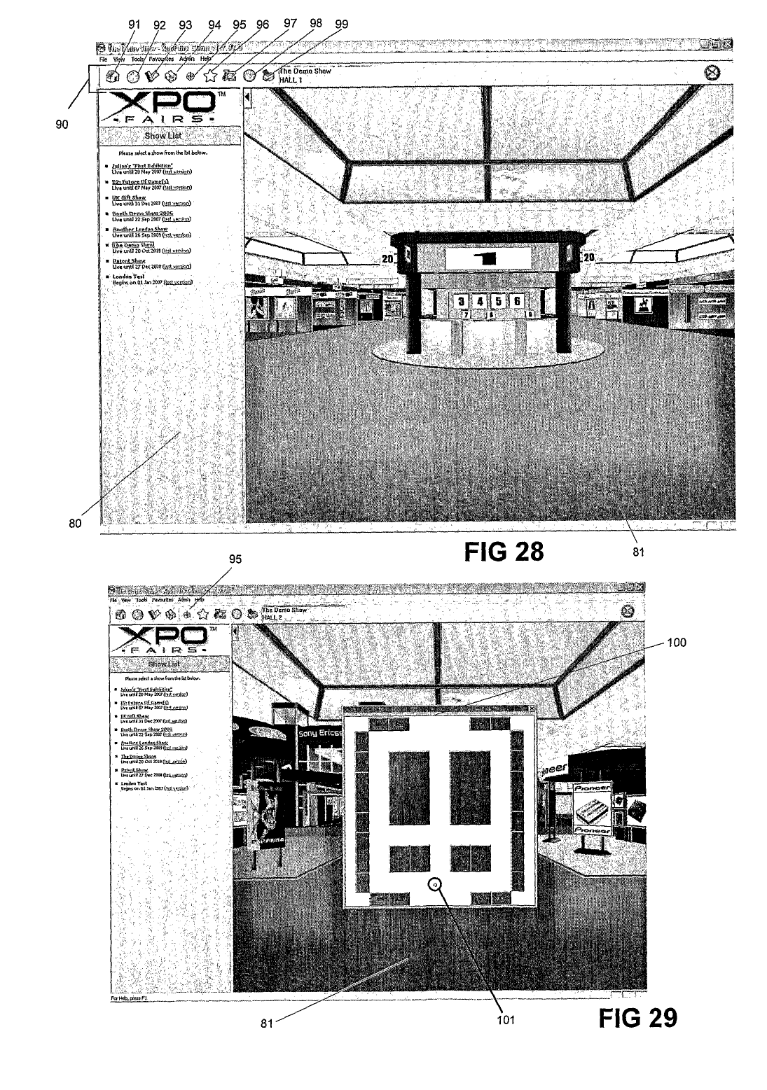

FIG. 28 is a screenshot taken from the client application used in an embodiment of the present invention;

FIG. 29 is a screenshot showing a map of a hall provided by the client application;

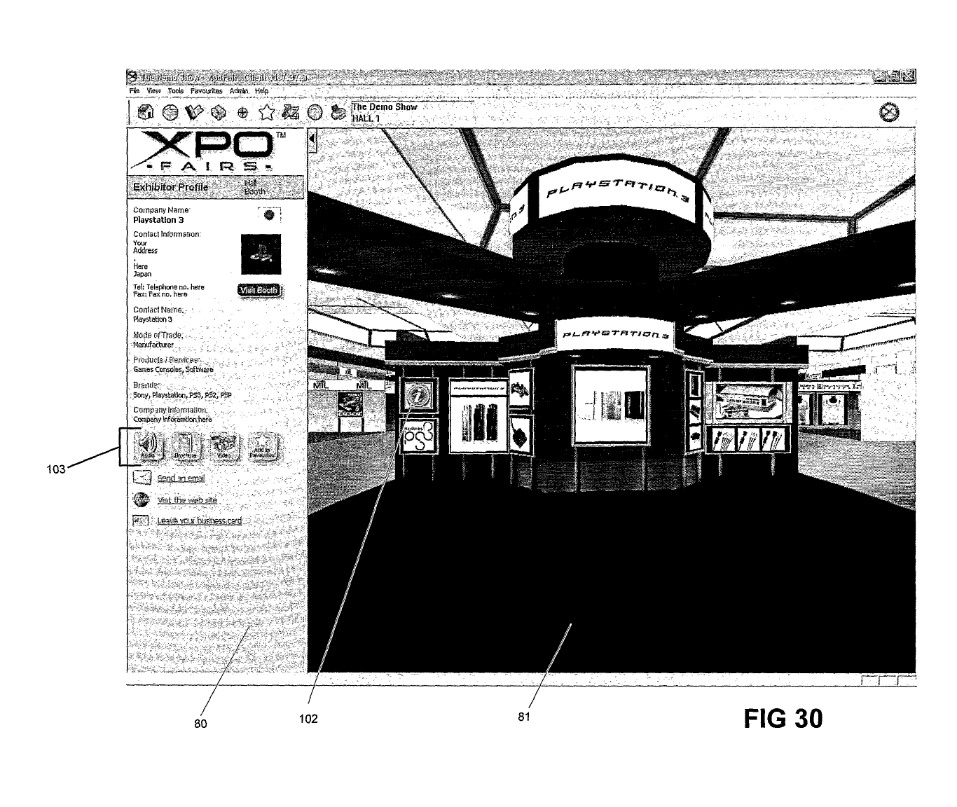

FIG. 30 is a screenshot showing exhibitor information provided by the client application;

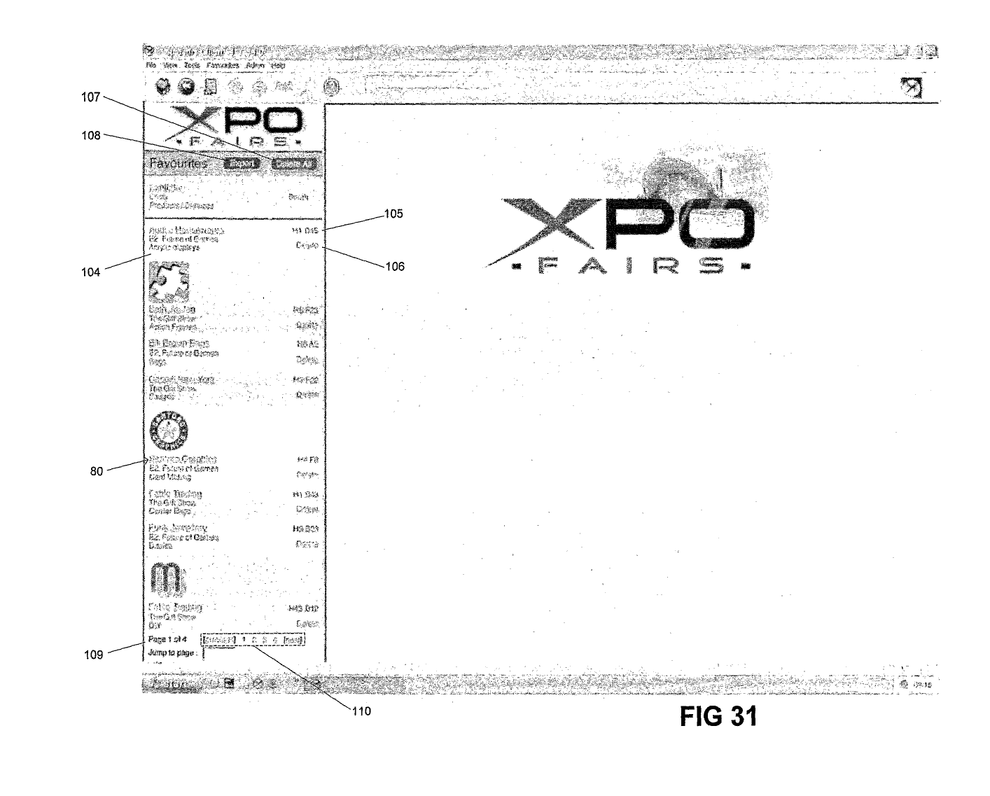

FIG. 31 is a screenshot showing how a user can view a list of favourite exhibitors using the client application;

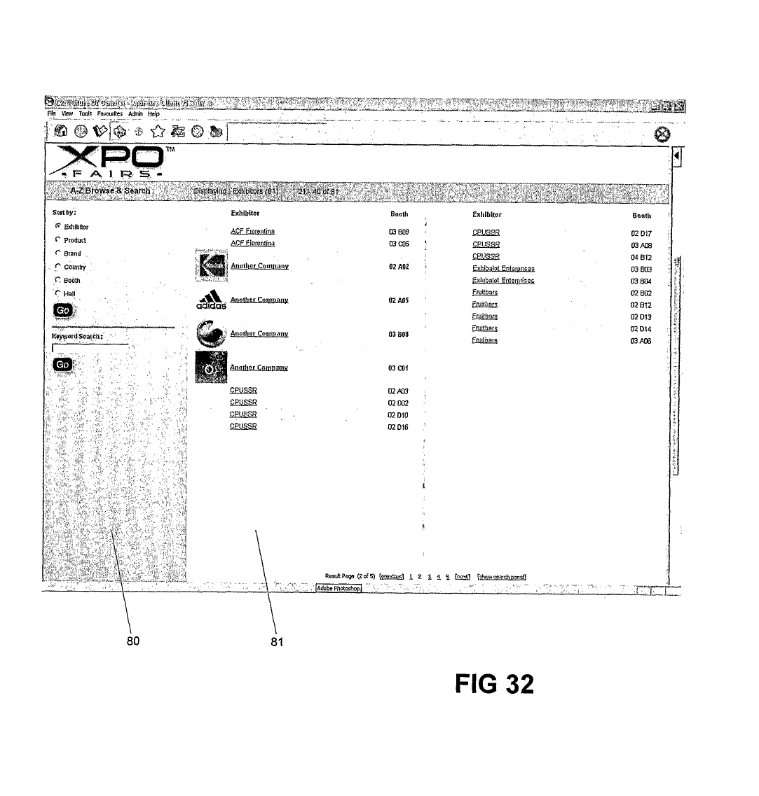

FIG. 32 is a screenshot showing an A to Z exhibitor listing provided by the client application;

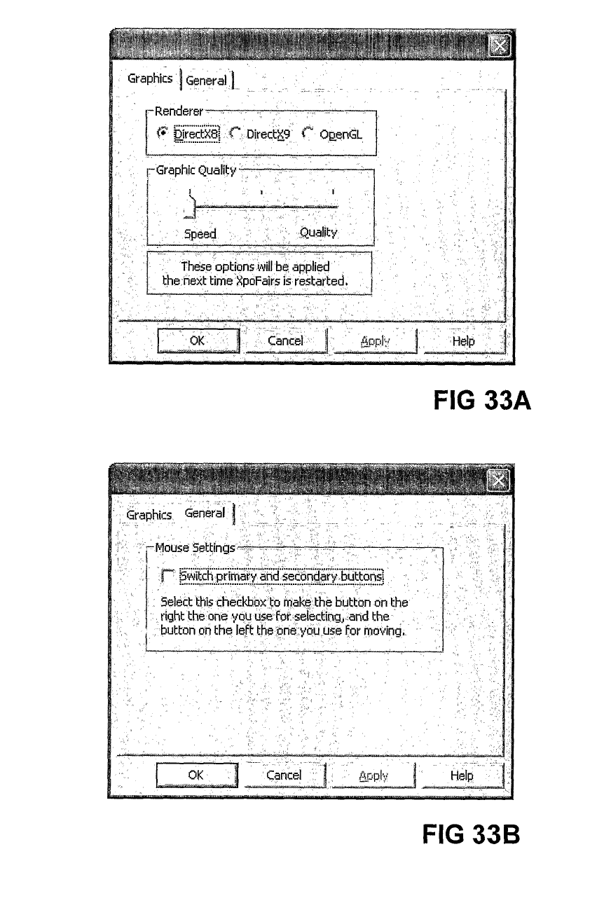

FIGS. 33A and 33B are screenshots of an options dialog provided by the client application;

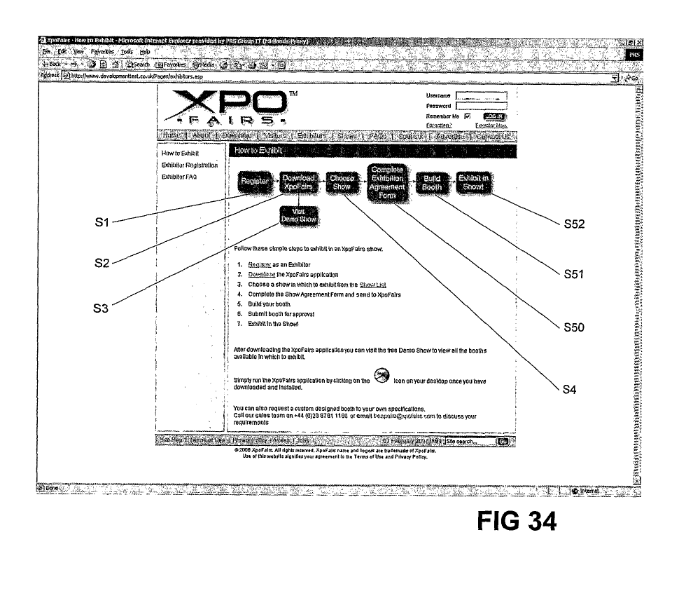

FIG. 34 is a screenshot of a webpage showing a process by which an exhibitor exhibits at an exhibition;

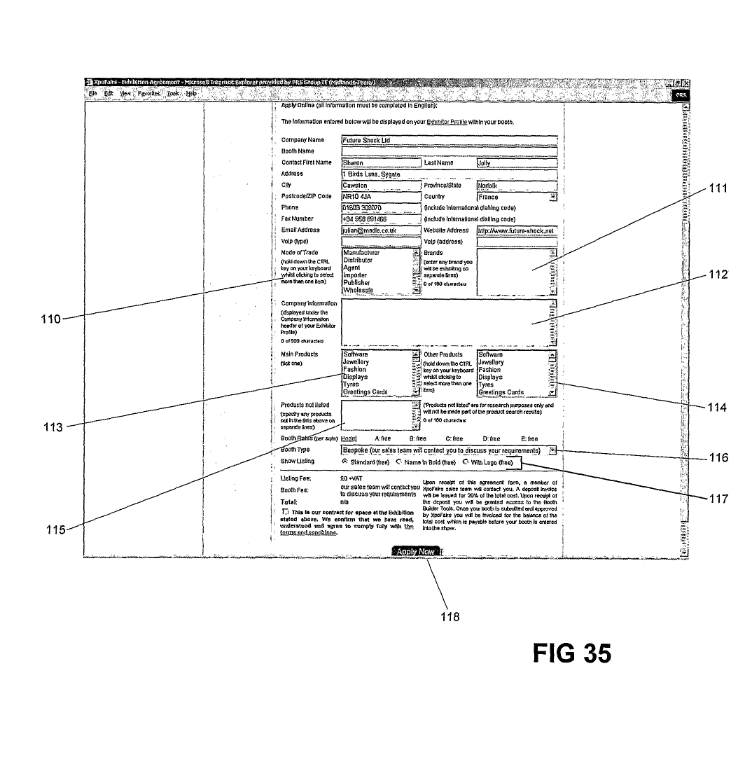

FIG. 35 is a screenshot of a webpage showing a registration form completed by an exhibitor;

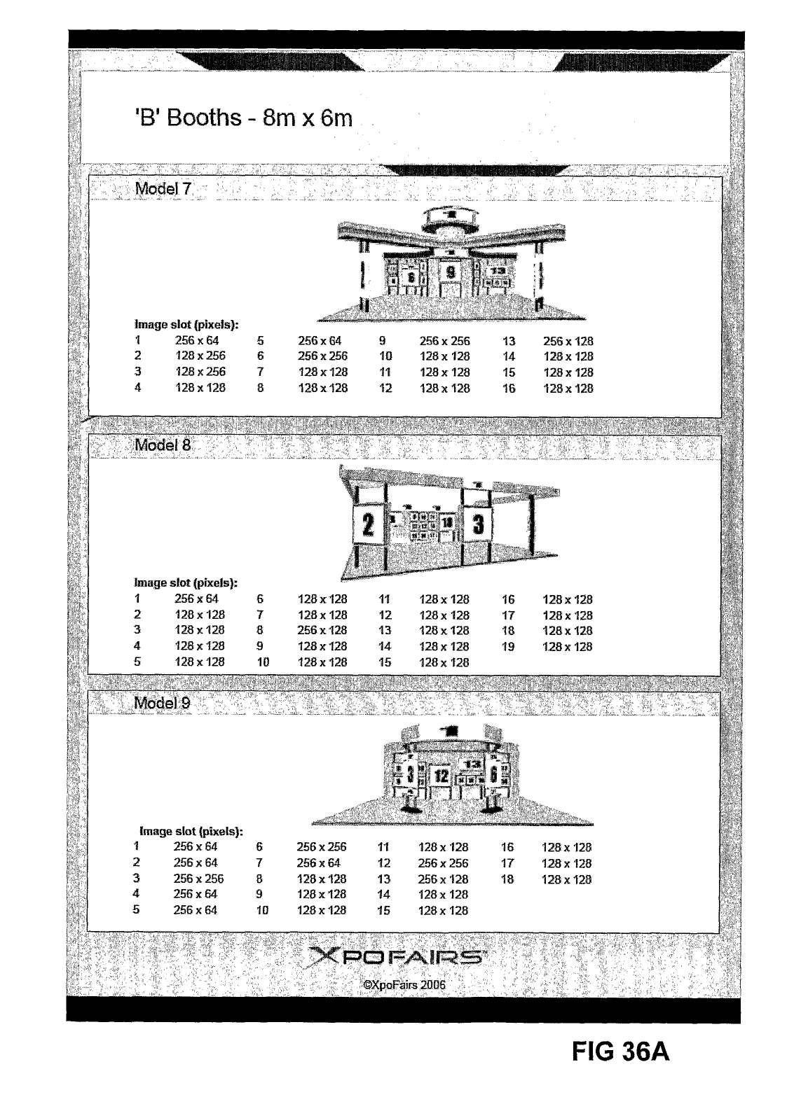

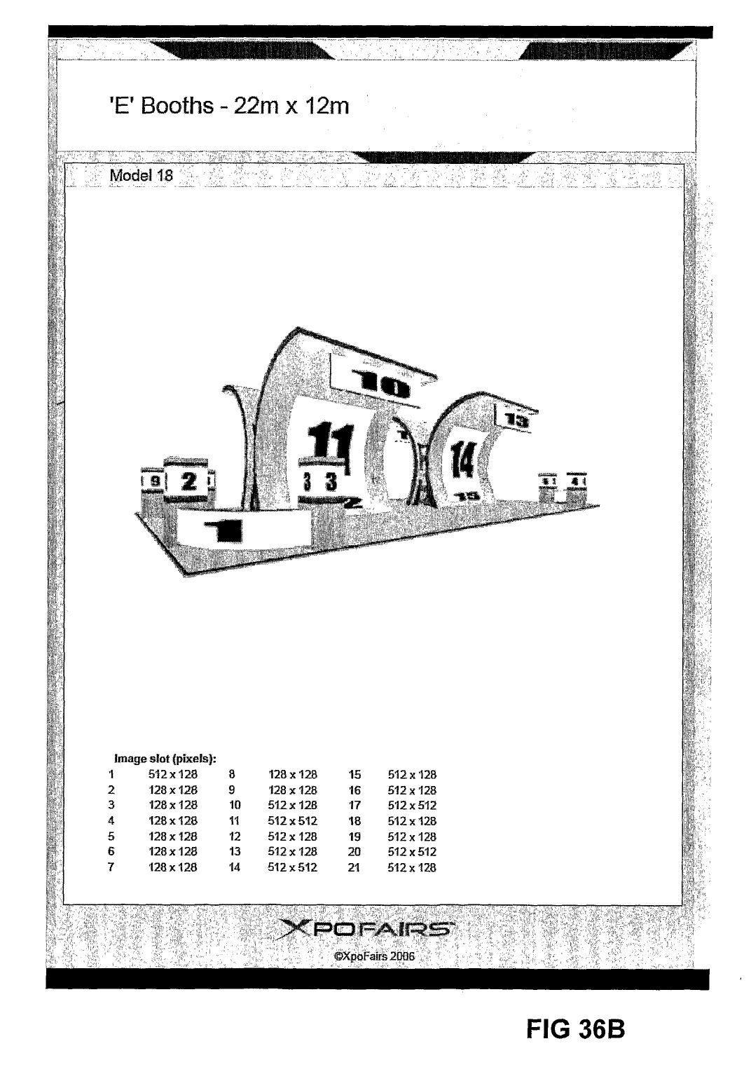

FIGS. 36A and 36B are datasheets showing parameters of booths from which an exhibitor may select;

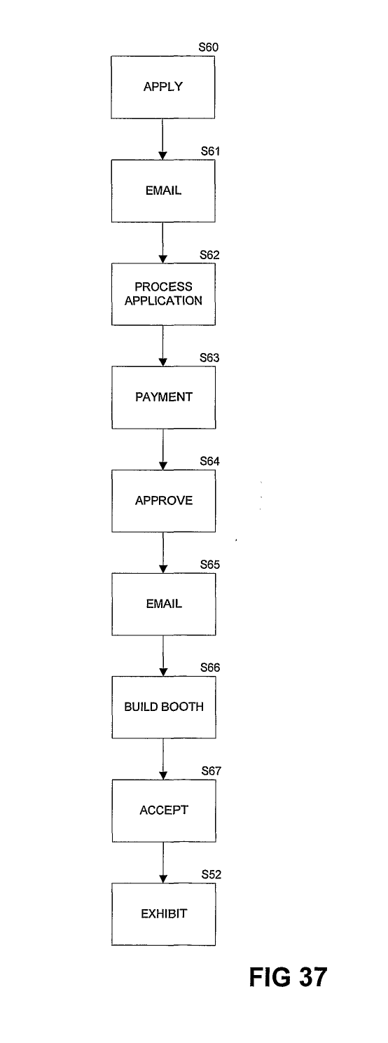

FIG. 37 is a flowchart of a process for creating a booth for inclusion in an virtual exhibition;

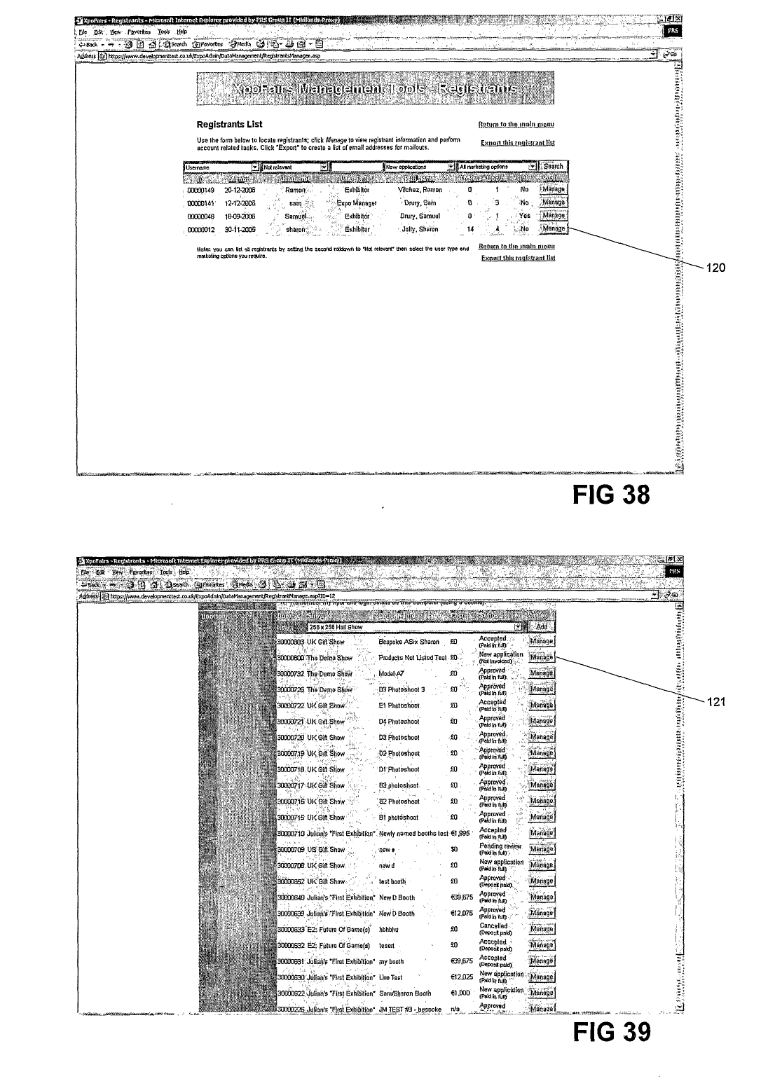

FIGS. 38 to 40 are screenshots of webpages used by an exhibition administrator to process exhibitor applications;

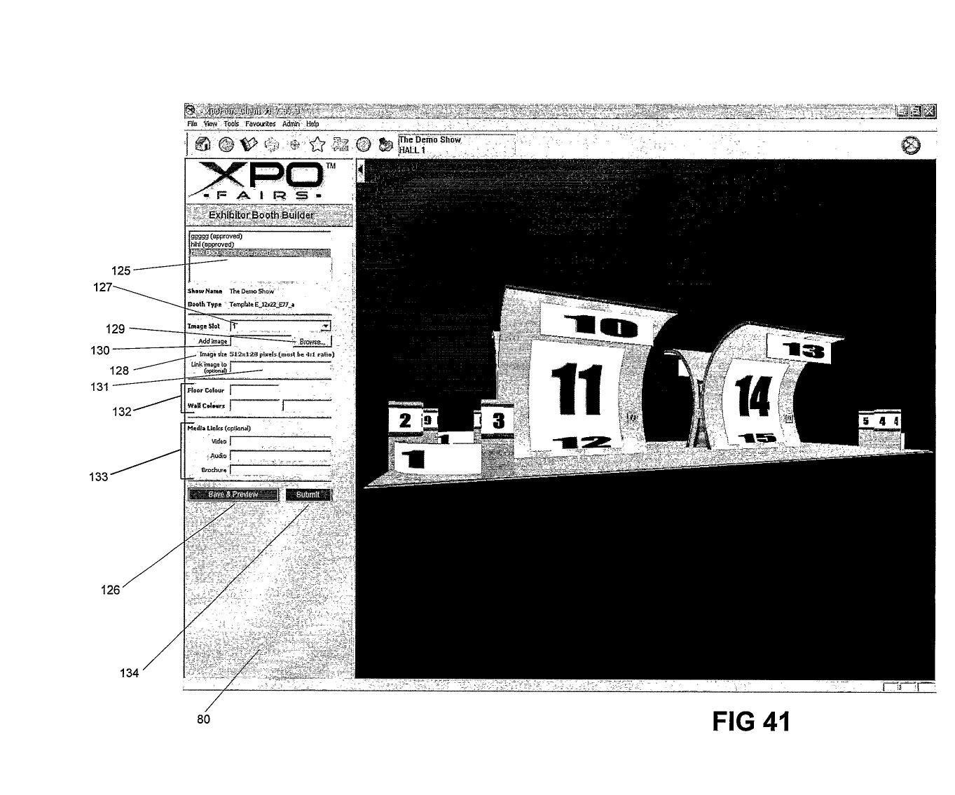

FIG. 41 is a screenshot showing how the client application allows an exhibitor to configure a booth;

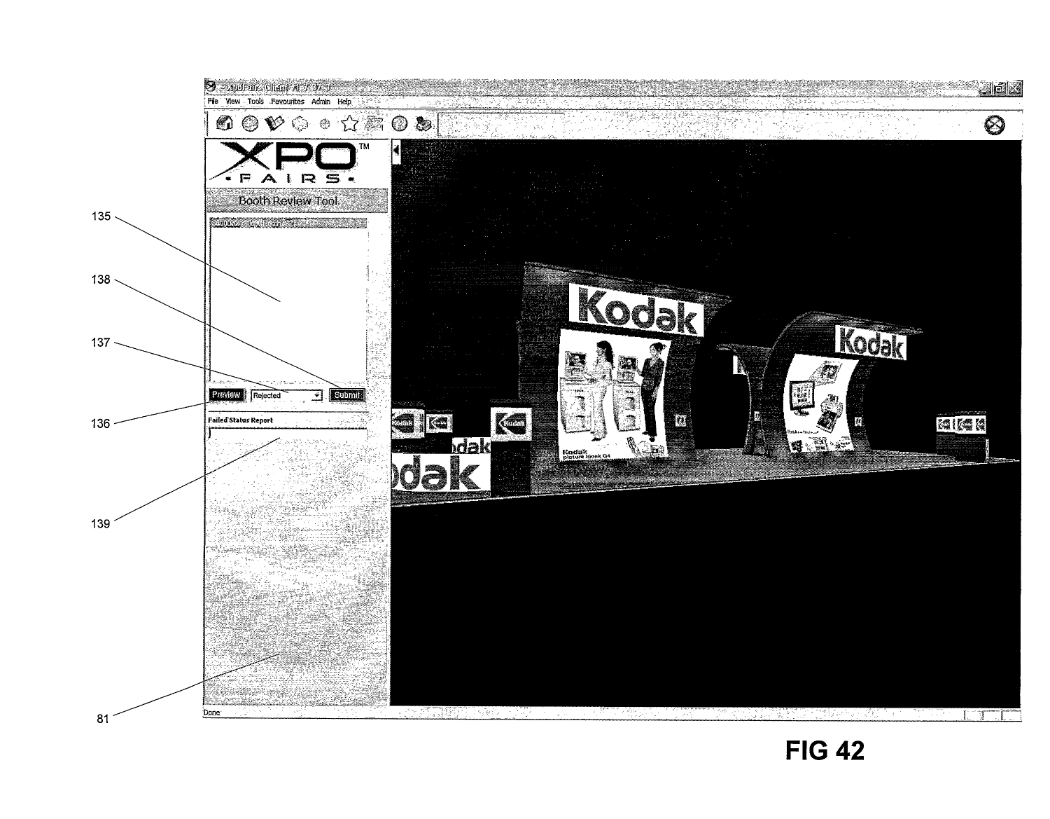

FIG. 42 is a screenshot showing how the client application allows an exhibition administrator to review a created booth;

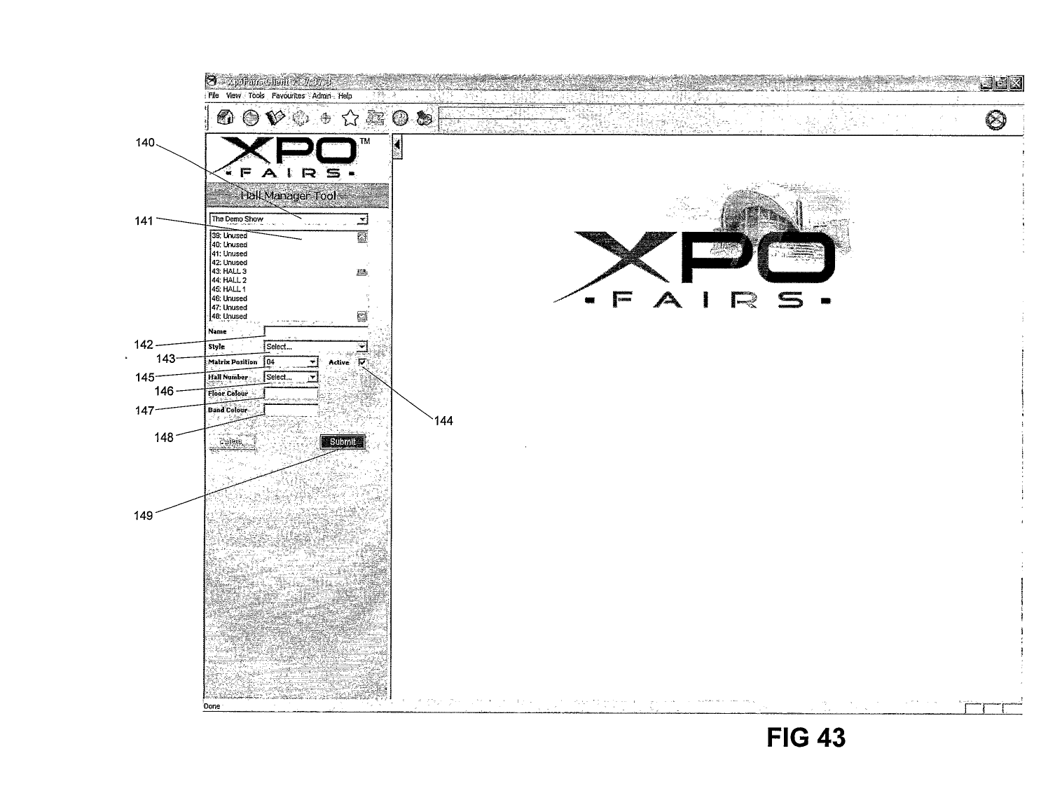

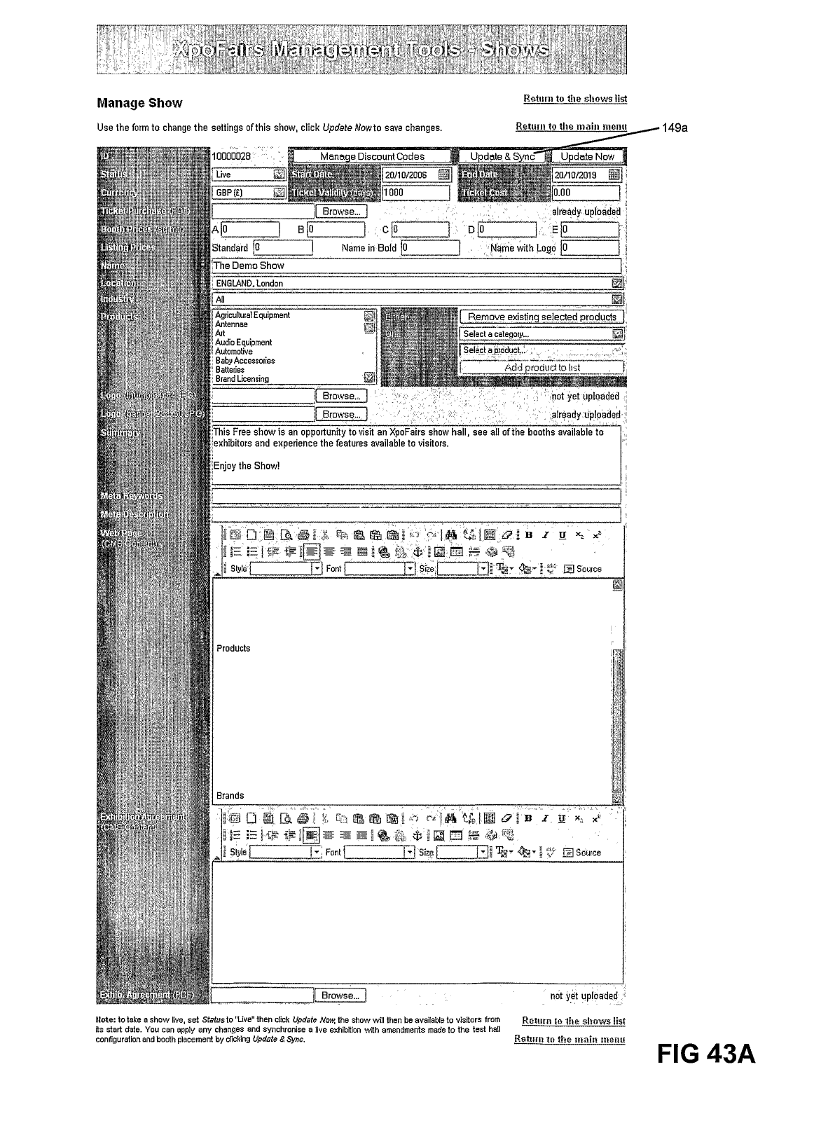

FIG. 43 is a screenshot showing how the client application allows an exhibition administrator to configure halls within a virtual exhibition;

FIG. 43A is a screenshot of a webpage used to configure a virtual exhibition;

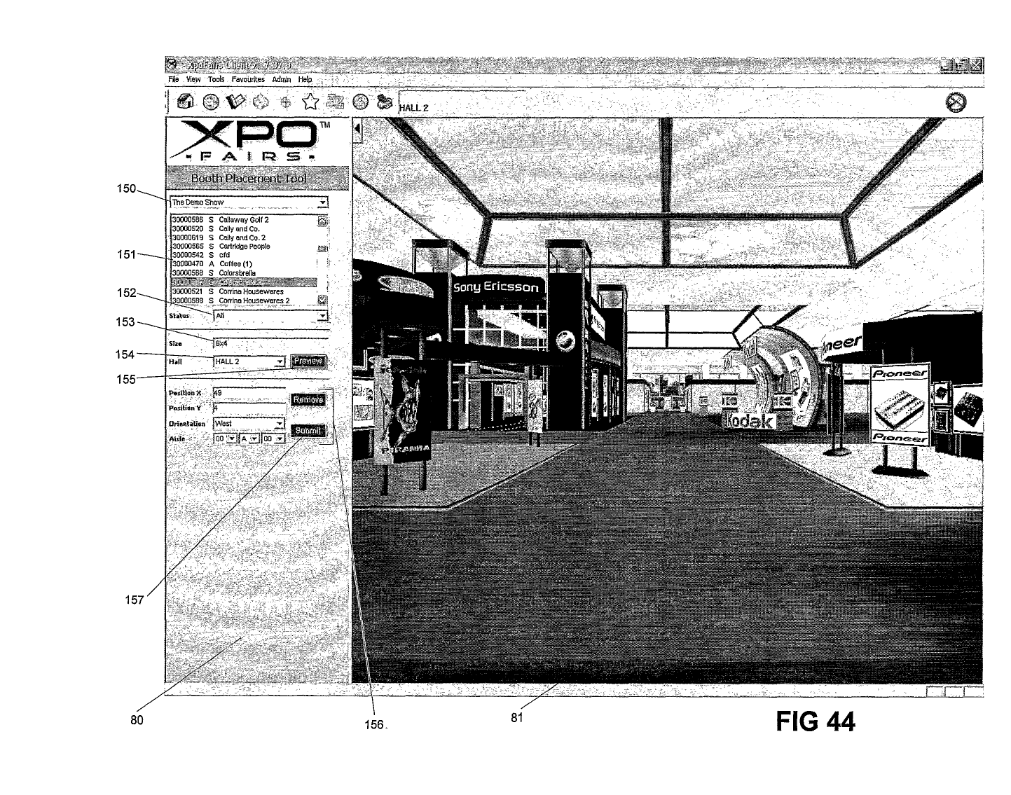

FIG. 44 is a screenshot showing how booths can be placed in an exhibition hall using the client application;

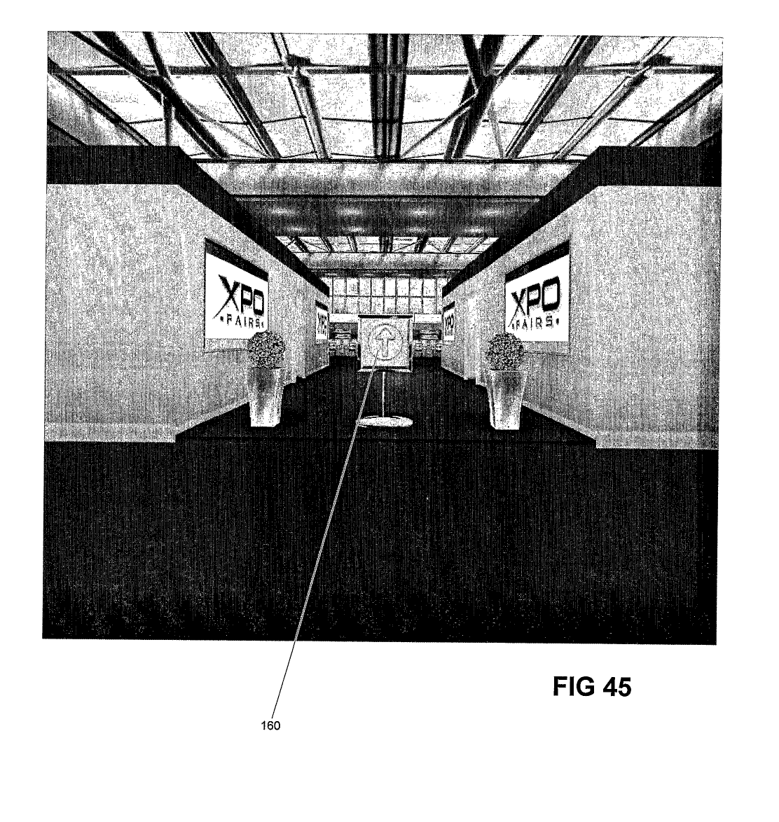

FIG. 45 is a screenshot taken from the client application showing how a user can move between halls; and

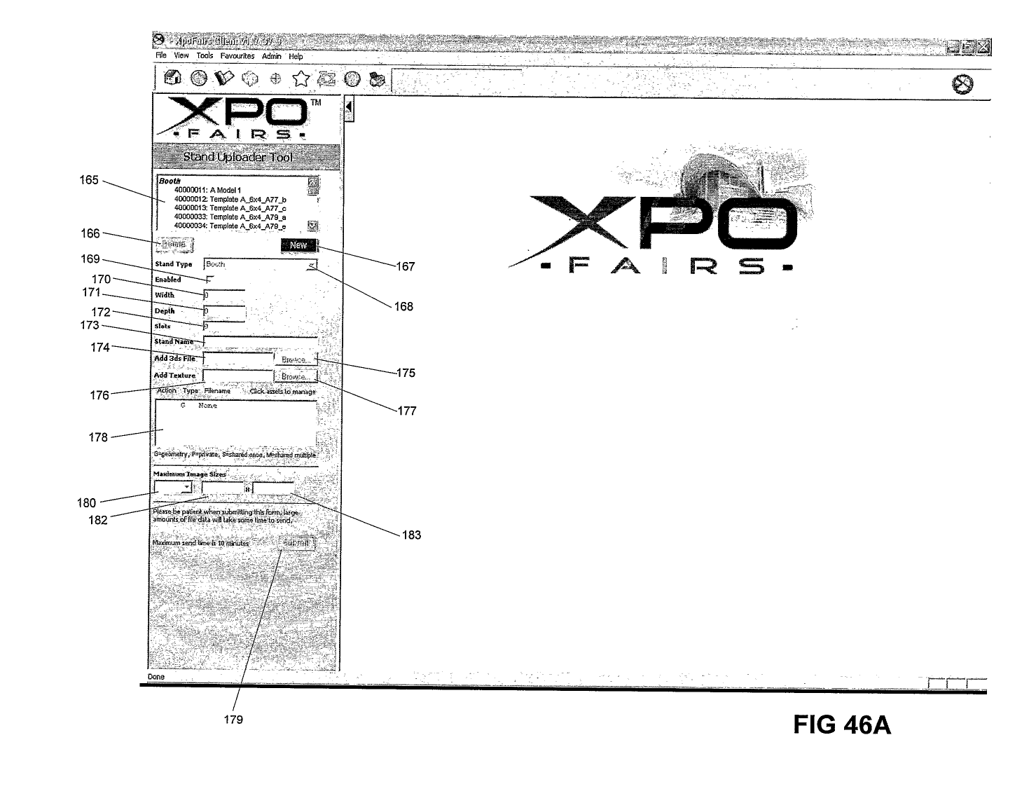

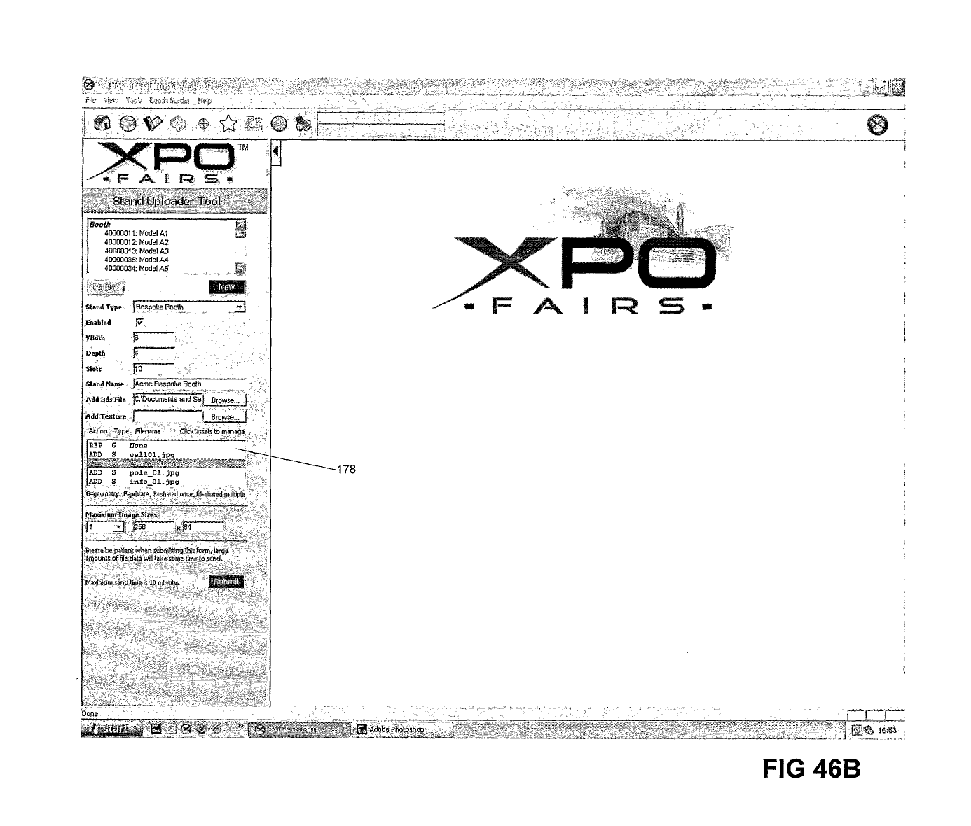

FIGS. 46A and 46B are screenshots showing how graphical data can be uploaded.

Embodiments of the present invention provide an interactive environment in which virtual exhibitions (such as trade shows) can be created, maintained and visited. FIG. 1 shows a schematic illustration of the environment provided by an embodiment of the invention.

Referring to FIG. 1, a management system 1 provides access to a plurality of virtual exhibitions 2. The virtual exhibitions 2 can be accessed by visitors 3 who obtain tickets 4 from the management system 1 to allow them to access particular virtual exhibitions. As described in further detail below, the virtual exhibitions are preferably provided in the form of a three dimensional graphical scene through which the user can navigate.

Each virtual exhibition comprises a plurality of booths, being representations of booths such as those found at a conventional exhibition. Each booth is created and managed by an exhibitor 5 who uses the management system 1 to customise their booth or booths. It can be seen from FIG. 1 that an administrator 6 also uses the management system 1 to configure exhibitions, as well as to manage the sale of tickets to visitors, and the allocation and sale of booths to exhibitors.

The management system 1 is preferably accessible over the Internet. An embodiment of the invention using the Internet is now described.

FIG. 2 shows a network of computers including the Internet 7. It can be seen that client computers in the form of a desktop PC 8 a laptop PC 9 and a Personal Digital Assistant (PDA) 10 are provided with access to the Internet 7. A webserver 11 and database server 12 are also provided with access to the Internet 7. In this way the client computers can access data stored on the web server 11 and the database server 12. The database server manages a database 13, the structure of which is described in further detail below. Data stored in the database 13 is made available to the client computes connected to the Internet 7 by the database server 12. The database server 12 controls access to the database 13 so as to preserve the security and integrity of data in the database 13.

A connection between the web server 11 and the database server 12 is also shown. This connection allows the web server 11 to obtain data from the database 13 and include such data in web pages provided over the Internet 7. Although shown as a direct connection, it will be appreciated that the connection between the web server 11 and the database server 12 need not, in fact be a direct connection, but can instead be a connection over a network such as a local area network or a distributed network such as the Internet.

FIG. 3 shows a schematic illustration of the desktop PC 8 shown in FIG. 1. It can be seen that the desktop PC 8 comprises a CPU 14, together with volatile storage in the form of RAM 15. The RAM 15 stores instructions which can be read and executed by the CPU 14, as well as storing data which is processed by those instructions. The desktop PC 8 further comprises non-volatile storage in the form of a hard disk drive 16. An input/output interface 17 is also provided. It can be seen in FIG. 3 that a plurality of input/output devices are connected to the input/output interface 17, comprising a screen 18, a keyboard 19 and mouse 20. The desktop PC 8 also comprises a network interface 21 allowing the desktop PC 8 to connect to a wired or wireless local area network (LAN).

The desktop PC 8 shown in FIG. 3 gains access to the Internet 7 using the network interface 21. Specifically, if the desktop PC 8 is connected to a LAN including a computer having Internet connectivity, the desktop PC connects to the Internet 7 using the LAN and the computer having Internet connectivity. Although the desktop PC 8 connects to the Internet 7 in this way, it will be appreciated that Internet connectivity for each of the client computers can be provided in any convenient way. For example, the laptop PC 9 may be provided with a modem allowing a dialup connection to be established with a remote computer, the remote computer being provided with Internet connectivity, such that in turn the laptop PC 9 also has Internet connectivity. Such a dialup connection can, of course, take the form of a so-called broadband connection providing relatively high data transfer speeds.

Having described the hardware used to implement an embodiment of the invention, the software used is now described, first with reference to FIG. 4 which shows part of the desktop PC 8 in further detail. In general terms, while much of the following description refers to operation of the desktop PC 8, it will be appreciated that the operation of the laptop PC 9 and PDA 10 is analogous.

In operation, the desktop PC 8 (and indeed any of the client computers used to implement the invention) runs a web-browser 22 and a client application 23. As shown in FIG. 4, instructions for the web-browser 22 the client application 23 are both stored in the RAM 15. The RAM 15 further stores instructions 24 defining an operating system which runs on and manages operation of the desktop PC 8. The CPU 14 reads and executes instructions stored in the RAM 15 in a conventional way, allowing the behaviour of the desktop PC 8 to be affected by the instructions. The operating system provides management of various system functions. In particular, the operating system provides management of network functions provided by the network interface card 21. In this way both the client application 23 and the web-browser 22 are able to receive and transmit data over the Internet 7.

FIG. 5 schematically shows how the client application 23 and the web browser 22 running on the desktop PC 8 receive and transmit information over the Internet 7. Specifically, it can be seen that the web browser 22 requests web pages from the web server 11, and in response to such request the web server 11 transmits web pages to the web browser 22. The client application 23 also requests and receives web pages from the web server 11. However the client application 23 also requests and receives data directly from the database server 12, which accesses and provides data stored in the database 13. In FIG. 5 direct connections between the web browser 22 and web server 11 and between the client application 23 and each of the web server 11 and database server 12 are shown. It will be appreciated that in many embodiments of the invention such direct connections are not provided, but rather conventional network routing techniques are provided to allow the necessary data to pass over the Internet 7.

Having described components used to implement an embodiment of the invention, both in terms of hardware and software, FIG. 6 shows a how data representing virtual exhibitions is arranged in an embodiment of the invention. Data 25 is stored representing a particular virtual exhibition. A virtual exhibition is defined by a plurality of halls, which are analogous to exhibition halls which make up a “real” exhibition. It can be seen that the virtual exhibition represented by the data 25 is made up of two halls represented by data 26a, 26b. The data 26a, 26b will refer to the data 25 (as is described in further detail below) so as to capture the link between the exhibition and the halls making up the exhibition. Each hall comprises a plurality of booths, each booth being used as an exhibition space by a particular exhibitor. In the example of FIG. 6, the hall represented by the data 26a comprises three booths, each represented by respective data 27a, 27b, 27c. Similarly the hall represented by the data 26b comprises two booths, each represented by respective data 28a, 28b. In this way, it can be seen that data defining an virtual exhibition is defined hierarchically. It will be appreciated that although FIG. 6 shows a single virtual exhibition comprising two halls having three and two booths within them, in embodiments of the invention a plurality of virtual exhibitions will be provided, each typically having a plurality of halls, and each hall having a greater number of booths than those shown in the example of FIG. 6.

Having described data used to represent virtual exhibitions in general terms, a database structure suitable for storing such data is now described, first with reference to FIG. 7. A database having the structure shown in FIG. 7 forms at least part of the database 13 discussed above. The database is a relational database defined by a plurality of tables which are now described. The tables are first described at a high level with reference to their relationships to others of the tables. A more detailed description of data stored in the various tables is presented below.

An Exhibitions table 30 stores data relating to virtual exhibitions which visitors can visit and at which exhibitors can exhibit. Each exhibition has a relationship with a record of the Locations table 31, the relationship indicating a geographical location with which the exhibition is associated. It can be seen that a plurality of virtual exhibitions can be associated with a particular location, while each exhibition can be associated with only a single location. As described above, virtual exhibitions are made up of one or more halls, each hall being a record of the Halls table 32. Similarly halls are made up of booths, each booth being represented by a record of the Booths table 33. It can be seen that each record of the Halls table 32 is associated with a single record of the Exhibitions table 30, and that similarly, each record of the Booths table 33 is associated with a single record of the Halls table 32.

Virtual exhibitions of the type discussed herein are presented as interactive three-dimensional graphics. Both halls and booths are represented by appropriate three-dimensional models which are represented by records of the Models table 34. It can be seen that models are reusable, in that a single record of the Models table 34 can be associated with a plurality of records in the Halls table 32 or the Booths table 33. A ModelAssets table 35 is provided to store relationships between records of the Models table 34 and records of an Assets table 36. The Assets table 36 provides data allowing particular assets (for example graphical objects) to be located by means of file names, as is described in further detail below. It can be seen that each record of the Models table 34 can refer to a plurality of records of the ModelAssets table 35, while each record of the ModelAssets table 35 is associated with a single record of the Models table 34. It can further be seen that each record of the ModelAssets table 35 is associated with a single record of the Assets table 36, while each record of the Assets table 36 is associated with one or more records of the ModelAssets table 35. In this way it will be appreciated that assets represented by records of the Assets table 26 can be associated with a plurality of records of the Assets table 36.

Booths represented by records of the Booths table 33 are made up of a plurality of slots, each slot representing a part of a booth intended to display a particular image, such as an advertising poster or logo. Such slots are represented by records of a Slots table 37, which is related to the Booths table 33 by a BoothSlots table 38. Each slot has an associated model and a relationship therefore exists between the Slots table 37 and the Models table 34. It can be seen that each record of the Booths table 33 can refer to a plurality of records of the BoothSlots table 38, while each record of the BoothSlots table 38 is associated with a single record of the Booths table 33. Additionally, each record of the BoothSlots table 38 is related to a single record of the Slots table 37, while each record of the Slots table 37 can be related to a plurality of records in the BoothSlots table 38. This means that each booth represented by a record of the Booths table 33 can have a plurality of slots, while slots can be shared between booths.

The preceding description of FIG. 7 has been concerned with the structure of data used to represent virtual exhibitions. Referring back to FIG. 1, it will be appreciated that embodiments of the invention also need to store data relating to users of the system, those users being visitors or exhibitors. Users are represented by records of a Registrants table 39. It can be seen that the Registrants table 39 has a relationship with the Booths table 33, allowing data representing an exhibitor associated with each booth to be stored. It can be seen that while each record of the Booths table 33 is associated with a single record of the Registrants table 39, each record of the Registrants table 39 can refer to a plurality of records of the Booths table 33.

The Registrants table 39 also has a relationship with a Tickets table 40. The Tickets table 40 stores data indicating tickets allowing visitors to visit virtual exhibitions. It can be seen that the relationship between the Tickets table 40 and the Registrants table 39 is such that each visitor (represented by a record of the Registrants table 39) can be associated with a plurality of tickets, while each ticket is associated with a single visitor. It may be desired to offer discounted tickets to particular exhibitions. A Discounts table 41 represents such discounts, and records of the Discounts table 41 are associated with the Exhibitions table 30 and the Tickets table 40. It can be seen that a particular record of the Discounts table 41 refers to a single record of the Exhibitions table 30, while a single record of the Exhibitions table 30 can refer to a plurality of records of the Discounts table 41 (i.e. an exhibition can have a plurality of different discount schemes). Each ticket represented by a record of the Tickets table 40 can be associated with a single record of the Discounts table 41, while each record of the Discounts table 41 can be associated with a plurality of records of the Tickets table 40.

Various products are also represented by data stored in the database, and such products are represented by records of a Products table 42. Such products represent products which are displayed at an exhibition. Each record of the Products table 42 refers to a single record in a ProductCategories table 43, so as to allow products to be suitably arranged. A BoothProducts table 44, an ExhbitionProducts table 45 and a TicketProducts table 46 are also provided. The BoothProducts table 44 has a relationship with the Booths table 33, the ExhibitionProducts table 45 has a relationship with the Exhibitions table 30, while the TicketProducts table 46 has a relationship with the Tickets table 40. In this way a convenient mechanism is provided for associating products with exhibitions in which they are displayed, with booths on which they displayed, and which particular tickets. The relationship between products and tickets allows a visitor holding a ticket to associate their ticket with a particular product, thereby allowing monitoring of visitor interests.

The database also includes various other tables which are primarily used for system management purposes. These tables include a SystemSettings table 47, an ExpoCounters table 48, a SupportRequests table 49, and a CMSPages table 50. The SystemSettings table 47 stores various settings which are relevant to the system, while the ExpoCounters tables monitors visitors to a particular virtual exhibition as is described further below. The SupportRequests table 49 stores details of support requests received over the Internet. The CMSPages table 50 is used to store content which is to be included on web pages.

Having described constituent tables of the database, the data stored in the tables is now described with reference to FIGS. 7A to 7M.

FIG. 7A shows fields of the Exhibitions table 30. An EID field acts as a primary key for the table. An LID field references a record of the Locations table 31, which is described below with reference to FIG. 7B. Virtual exhibitions have associated start and end dates which are represented respectively by a StartDate field and an EndDate field. A status field takes a value of 0 if a virtual exhibition is not live (i.e. the virtual exhibition has not yet started and cannot be visited), a value of 1 if the virtual exhibition is live, and a value of ±1 if the virtual exhibition has been cancelled. Exhibitors at a virtual exhibition have entries in an exhibitor listing, as is described in further detail below. Such entries take a number of forms, including a basic form, and emboldened form an a form including a logo. Prices for such entries are represented by a Price field, a PriceBold field and a PriceLogo field.

As described above, exhibitors have booths at a virtual exhibition, and such booths can take a variety of forms, in terms of size and style. Different booths have different associated costs. In the described embodiment, booths take one of five forms referred to as A to E, each form having an associated price represented by a PriceA field, a PriceB field, a PriceC field, a PriceD field and a PriceE field. A currency in which prices are stored is represented by a Currency field. A virtual exhibition has a name and some associated textual data which are respectively represented by a Name field and a Summary field.

Tickets will vary in price between exhibitions. A TicketCost field stores a ticket price for the virtual exhibition. Tickets will vary in validity between exhibitions. A TicketValidity field therefore stores a number of days for which a ticket is valid after purchase. A virtual exhibition will have an associated webpage and text for this webpage is stored in a CMScontent field.

It is desirable to allow potential visitors to search for virtual exhibitions of interest. This is made possible by associating metadata with virtual exhibitions. Such metadata is stored in a MetaKeywords field and a MetaDescription field. A Hitcount field indicates a number of tickets sold for an exhibition, while an Industry field stores a textual description of the industry with which the exhibition is associated. Text for an exhibitor agreement is stored in an ExhibAgreeCMS field.

ExhibAgreePDF, TickPurchPDF, LogoThumb and LogoFull fields each store a single bit of data. These fields are respectively used to indicate whether a document (in this case a PDF file) outlining an exhibitor agreement has been uploaded, whether a document (in this case a PDF file) outlining a ticket purchase agreement has been uploaded, whether a graphics file containing a thumbnail logo has been uploaded, and whether a graphics file containing a full size logo has been uploaded.

The Locations table 31 is shown in FIG. 7B. A LID field acts as a primary key. Country and City fields are used to define a geographical location, while Xpos and Ypos fields are used to relate that location to a map position, thus allowing a map of locations to be displayed.

The Halls table 32 is shown in FIG. 7C. It can be seen that a HID field acts as a primary key while an EID field identifies a virtual exhibition represented by a record of the Exhibitions table 31. LiveMOID and TestMOID field both identify records of the Models table 34 which is described in further detail below. A Name field stores a textual name for the hall which can be displayed to a user. A HitCount field indicates a number of visitors who have accessed the hall.

A LiveMatrixPos field stores a number which is interpreted as discussed below to locate a hall within a plan of halls making up a virtual exhibition. A LiveFloorColour field defines a hall's floor colour, while a LiveBandColour defines a hall's “band” colour, that being a coloured band running around the hall's walls as described in further detail below. A LiveHallNumber field assigns a number to the hall for the purposes of reference. TestMatrixPos, TestFloorColour, TestBandColour and TestHallNumber fields store equivalent data to like named fields beginning “Live”. In general terms these test fields are used while an exhibition is configured, with data being copied from test fields to live fields when a hall is to be visited by a visitor.

FIG. 7D shows the Booths table 33. A BID field acts as a primary key, while an EID field references a record of the Exhibitions table 30. An MOID field references a record of the Models table 34, while an RID field references a record of the Registrants table 39. DateAdded, DatePlaced and DateRemoved fields store dates relevant to a particular booth. Booths also have a version stored in a Version field. A Status field is used store status information and takes a value of 0 if a booth is in development, a value of 2 if a booth has been accepted, a value of −1 if a booth has been rejected, a value of −2 if a booth has been cancelled and a value of −10 if a booth is still in its application stage.

A booth has a name which is stored in a Name field. Two wall colours and a floor colour are respectively stored in fields named WallColour1, WallColour2 and FloorColour. VideoLink, AudioLink and CatalogueLink fields are used to store web-links which can be invoked from that booth. A PriceCharged field stores data indicating an amount charged for the booth, while an AdminMessage field is used to store messages generated by a system administrator, specifically to store data indicating why a rejected booth has been rejected. The process of booth review and rejection is described in further detail below.

A LiveHID field identifies a hall in which the booth is placed, while LiveXpos, LiveZpos and LiveRotation fields indicate positioning within that hall. A LiveAisle field is used to associate an aisle number with a booth which may be useful to a visitor navigating around the exhibition. Similarly named fields beginning “Test” serve corresponding purposes in development, rather than live, systems.

Fields are provided to monitor visitor interest in each booth. A HitCount field stores a number indicating how many times a booth has been downloaded, while InfoClicks, AudioClicks, VideoClicks, and BrochureClicks fields indicate how many times links associated with a booth have been invoked. The InfoClicks field represents a number of times which a link causing an exhibitor profile to be displayed has been selected. AudioClicks, VideoClicks and BrochureClicks fields respectively indicate a number of times which corresponding links in the exhibitor profile have been selected. A FavoriteAdds field stores a number of times a booth has been added to a user's favourite booths.

A ShowListing field stores textual data defining an entry in a virtual exhibition listing associated with the booth. A LogoUploaded fields indicates whether a logo associated with the booth has been uploaded. Various fields are provided to store data relating to the company associated with the booth, such data including a company name, and individual's contact details, address, telephone and Internet contact details.

A ModesOfTrade field stores textual data defining how a booth owner is willing to trade. A Brands field stores details of brands associated with the booth. A CompanyInformation field stores textual information providing company information. A ProductsNotListed field stores details of products associated with a booth which are not stored as standard products, as described below.

A PaymentStatus field indicates whether a booth has been paid for, recording whether a deposit of full price has been paid. A BespokeAssigned field is used to indicate whether a booth is based upon a standard template, or is a bespokely designed booth. This is described in further detail below.

FIG. 7E shows the Models table 34. It can be seen that an MOID field acts as a primary key. A ModelType field is used to indicate whether a record relates to a booth model, hall model, sign model, bespoke booth model or bespoke sign model. Each model has a name, a width, and a height, all stored in correspondingly named fields. Models can be enabled and disabled, as represented by an Enabled field.

FIG. 7F shows a ModelAssets table 35. An MAID field acts as a primary key, while an ASID field identifies a record of the Assets table 36 and an MOID field identifies a record of the Models table 34.

FIG. 7G shows the Assets table 36. An ASID field acts as a primary key. An AssetType field indicates a type of assets (e.g. model or image) to which a record relates. A Filename field provides a filename defining the asset while a Checksum stores a result of a checksum calculation on the file having the filename.

FIG. 7H shows the Slots table 37. An SLID field acts as a primary key. An MOID field identifies a model associated with a slot, while a SlotIndex provides an identifier for the slot, and MaxWidth and MaxHeight fields define a slot's size.

FIG. 7I shows the BoothSlots table 38 which stores details of relationships between the Slots table 37, the Booths table 33 and the Assets table 36. The BoothSlots table includes a BSID field which acts as a primary key, together with BID, SLID and ASID fields which respectively identify a record of the Booths table 33, the Slots table 37 and the Assets table 36. A Link field stores details of a hyperlink to be associated with the slot. It is to be noted that the BoothSlots table 38 provides a way of associating slots with booths, and of further associating images with those slots, the images being represented by records of the Assets table 36.

FIG. 7J shows the Registrants table 39. An RID field acts as a primary key, while DateAdded and DateUpdated fields respectively indicate a date on which a record was added, and a date on which a record was last updated. Username and Password fields store used identification details in a conventional way. An AccessLevel field indicates the nature of the registrant taking a value indicating visitor, sponsor, advertiser, exhibitor, booth reviewer, hall manager or expo manager. Each of these access levels has different abilities within the system, as will be described in further detail below. A number of fields in the Registrants table 39 store name, address and other contact information for a registrant. Further fields store data relating to a registrant's company such as a BusinessType field, and fields storing a number of employees and a value of sales. Data indicating a year in which the business was established, certifications held by the company, and a VAT number (sales tax registration number) are also provided. AllowMarketing and DataProtection fields are used to manage how the registrant's data is handled. A Privilege field is used to store data relating to a particular user's privileges within the system.

FIG. 7K shows the Tickets table 40. A TID field acts as a primary key. DID, RID and EID respectively identify records of the Discounts table 41, the Registrants table 39 and the Exhibitions table 30. ValidFrom and ValidTo fields indicate a ticket's validity, which DatePaid and Amount fields indicate a date on which the ticket was purchased and that amount paid. A VATrate field stores data indicating a rate of sales tax. A TransRef field indicates a transaction reference which may be taken from, for example, an Internet payment system. A UniqueRef field stores a unique reference number for the ticket represented by a particular record.

FIG. 7L shows the Discounts table 41. It can be seen that a DID field acts as a primary key, which an EID field identifies a record of the Exhibitions table 30 with which a record of the Discounts table 41 is associated. A DiscountAmount field stores a value indicating the amount of discount. An AutoDelete field indicates whether a discount record can be used only once, such that when used the Deleted field should be marked. It is to be noted that the Deleted field is marked instead of actually deleting a record so as to provide audit trail functionality.

FIG. 7M shows the ExpoCounters table 48. This table includes a row for each virtual exhibition for each day. The table includes a ECID field which acts as a primary key. An EID field identifies a record of the Exhibitions table 30 while a LogDate field identifies a date. Count fields identify the number of visitors in different categories who accessed the virtual exhibition on the day in question.

In general terms it has been indicated above that some fields have “Live” and “Test” equivalents. It should be noted that while “Test” fields are typically used for development purposes, “Live” fields are used for exhibitions which are to be visited by visitors. In much of the description that follows, reference is made to the processing of data stored in various of the “Live” fields, it will be appreciated that similar data can be processed from the equivalent “Test” fields in a development situation.

Having described data stored in an embodiment of the invention, operation of the invention is now described. In the described embodiment, as indicated above, operation of the invention is carried out using a web browser and a standalone client application. Operation of the embodiment of the invention using both the web browser and the standalone client application is now described. It has been indicated above that the system provided by the invention can be used by visitors to a virtual exhibition, and also by exhibitors. The system is first described from the point of view of a visitor.

FIG. 8 is a screenshot of a homepage presented to a user. It can be seen that the homepage includes a Visitors button 55 and an Exhibitors button 56. From this page a user selects one of these buttons. First, operation following selection of the Visitors button 55 is described. Following selection of the Visitors button 55 the screen shown in FIG. 9 is displayed to the user. This screen provides an overview flow chart of processes to be carried out before a user can visit a virtual exhibition, referred to in the screenshot as a “show”. Indeed, herein the terms “virtual exhibition” and “show” are used interchangeably unless the context requires otherwise. It can be seen that a first step S1 involves registration. Thereafter a user downloads the client application, referred to as XpoFairs, at step S2 and is able to view a demonstration show by way of example at step S3. Viewing this demonstration show involves a user obtaining a free ticket to visit the show, in much the same way that a user would buy a ticket to visit many other shows as described below. Having downloaded the client application, the user is able to select a show to visit at step S4, to buy a ticket for the selected show at step S5, and then to visit the selected show at step S6 using the downloaded client application. Each of these operations is described in further detail below.

FIG. 10 is a screenshot of a webpage completed by a user to effect registration. It can be seen that the user is required to choose a username and password, and further required to enter various personal details such as name, address and other contact details. Having completed the required information, the user selects a Register Now button 57 to complete registration. Completion of the registration process involves data input into the webpage of FIG. 10 being uploaded to the web server 11 (FIG. 2) from where it is passed to the database server 12 and the database 13. The registration process as described above collects all information required to populate a record of the Registrants table 39 shown in FIG. 7J.

Having registered, the user is able to download and install the client application, as indicated by step S2 of FIG. 9. The download process and installation of the client application on the user's computer is essentially conventional.

At step S4 of FIG. 9 a user is able to choose a virtual exhibition (or show) to be visited. This is carried out using a webpage of the type shown in FIG. 11. It can be seen that the webpage of FIG. 11 includes an upper area 58 displaying a map showing locations of various virtual exhibitions. Hovering a pointing device over virtual exhibition locations shown on the map causes a brief summary of virtual exhibitions taking place at that location to be displayed. This brief summary includes links which are selectable so as to obtain further information relating to the virtual exhibitions. It can also be seen that the screenshot of FIG. 11 includes an area 59 allowing a user to search for a virtual exhibition by entering an appropriate keyword into a text box 60, or by selecting an industry or location from appropriate drop down lists 61, 62. A pair of check boxes 63 is operable to indicate whether the search should include current and/or forthcoming virtual exhibitions. The screenshot of FIG. 11 also includes an area 65 which comprises a list of virtual exhibitions. Each entry in the list is selectable to obtain further information about a particular virtual exhibition.

Details of virtual exhibitions as shown in FIG. 11 are obtained by querying the database 13 (via the web server 11 and the database server 12) so as to obtain details of exhibitions which are currently running. Such data is then arranged into webpages of the type shown.

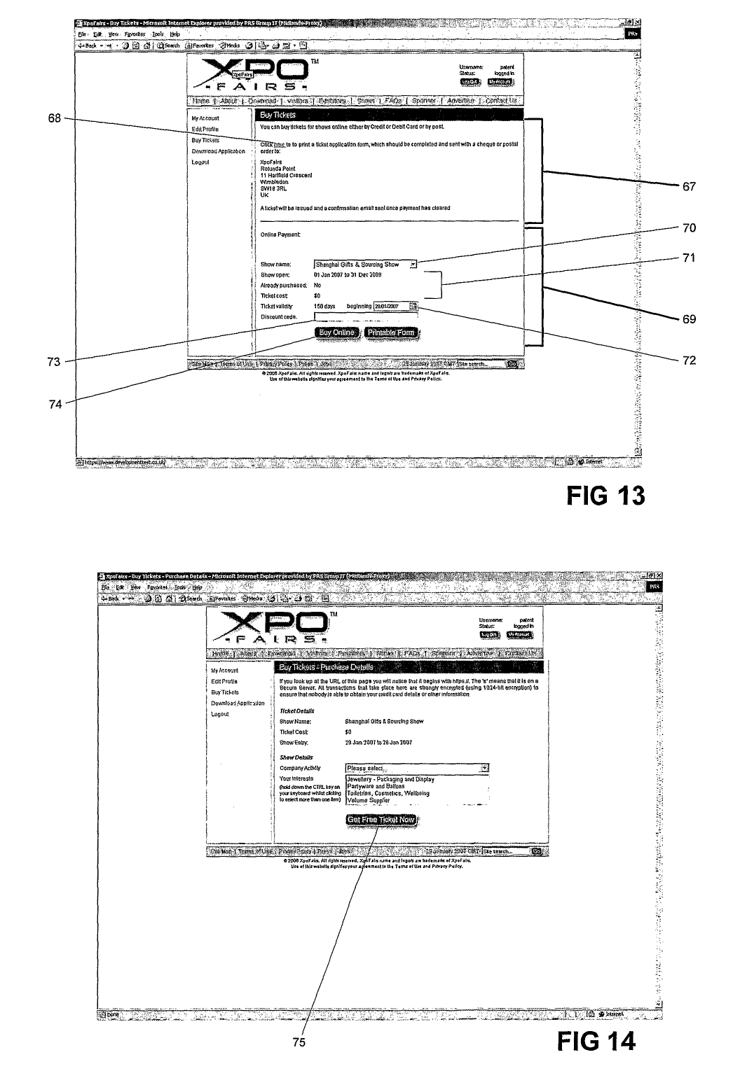

When further information about a particular exhibition is requested, either by use of summary information within the upper area 58 displaying the map or by selection of an entry in the area 65, a screen of the form shown in FIG. 12 is displayed. It can be seen that this screen provides summary information relating to the selected virtual exhibition. Further information relating the selected virtual exhibition is obtainable by selecting one of a plurality of links the area 66a. The screen shown in FIG. 12 also allows a user to buy a ticket by selecting a Buy Ticket button 66b, selection of which causes display of the screen shown in FIG. 13.

The screen shown in FIG. 13 provides two different purchase options. An upper part of the screen 67 provides a user with an option to print an application form which can be completed and returned by post. This process involves selection of a link 68 causing an appropriate application form to be downloaded. A lower part of the screen 69 allows a ticket to be purchased over the Internet. This involves selection of the appropriate virtual exhibition by using a drop down list 70. The drop down list 70 is initially configured to display details of the virtual exhibition shown in the screen of FIG. 12 which caused the screen of FIG. 13 to be displayed. An area 71 displays information about the virtual exhibition including dates between which the virtual exhibition runs, an indication of whether a user has previously purchased a ticket, and an indication of ticket price. An area 72 displays a duration for which a ticket is valid, and allows a user to select a date on which a ticket is run from. It will be appreciated that information relating to a virtual exhibition as is displayed in FIG. 12 can be obtained from the Exhibitions table 30 shown in FIG. 7A. A text box 73 is provided into which a discount code can be entered. A Buy Online button is selected to cause purchase of a ticket.

It will be appreciated that if the ticket is to be purchased over the Internet, and the ticket is sold for an amount of money, clicking the Buy Online button 74 will cause a link to an Internet payment merchant to be activated so as to allow a user to make an appropriate payment. However, in the case of the virtual exhibition shown in FIG. 13, it can be seen that the ticket price is $0, meaning that no payment need be collected in this case. This means that selection of the Buy Online button 74 causes display of a screen as shown in FIG. 14, where brief details of the virtual exhibition are again displayed, and the user is simply asked to indicate their company's activities, and their interests within the exhibition. In this case, selection of a Get Free Ticket Now button 75 causes an appropriate ticket to be allocated.

The preceding processing is used to populate a record of the Tickets table 40 shown in FIG. 7K. It should be noted that the ValidFrom field is populated by reference to the data entered in the area 72 of the screen shown in FIG. 13. The ValidTo field can then be populated with reference to the TicketValidity field of the Exhibitions table 30, shown in FIG. 7A.

Having purchased a ticket for a particular virtual exhibition of interest, a visitor makes use of the client application referred to above to visit and navigate around the virtual exhibition. On launching the client application a screen as shown in FIG. 15 is displayed. A log in dialog 76 is configured to receive a username and password to allow connection to the database server 12 (FIG. 1). It can be seen that a Work Offline button 77 is selectable to avoid the need to connect to the database server 12.

The username and password input using the log in dialog 76 are transmitted two and verified by the database server 12. The verification process involves the database server 12 indicating that verification has been unsuccessful such that further log in details are requested, or alternatively indicating that verification has been successful. In the case of successful verification, a left hand area of the screen shown in FIG. 15 is populated as shown in FIG. 16. The left hand area 80 includes entries for a plurality of virtual exhibition for which the user holds tickets. The data included in the left hand area 80 is received in the form of a HTML file which is created by the web server 11. Creation of this HTML file involves querying the Tickets table 40 on the basis of the user. Having obtained details of all currently valid tickets held by the user, details are of virtual exhibitions with which those tickets are associated are obtained from the Exhibitions table 30, and used to generate the HTML file. Entries shown in the left hand area 80 are selectable by the user to cause appropriate data to be downloaded and displayed in a right hand area 81.

Each of the entries in the left hand area 80 has an associated code, and this code is processed so as to download appropriate data defining the virtual exhibition, the downloaded data being configured to cause an interactive three-dimensional representation of the exhibition to be displayed in the right hand area 81. This process is now described with reference to FIG. 17.

When an entry in the left hand area 80 is selected, the associated code is transmitted by the client application to the database server 12 at step S10 in the form of a request for data. The transmitted code is received by the database server 12 at step S11, and data relating to the appropriate virtual exhibition is obtained at step S12. The obtained data is assembled for transmission to the client application at step S13. The located data is assembled into an XML file by the database server 12. The XML file is then transmitted to the client application at step S14, which file is received by the client application at step S15.

The XML file assembled at step S13 of FIG. 17 takes a form as illustrated in FIG. 18. The XML file is enclosed within <show> tags. Much of the data included within the XML file is obtained by querying the Exhibitions table 30 (FIG. 7A) using the code provided by the client application. A <name> tag indicates a show's name and is populated by reading data from the Name field of the Exhibitions table 30. A <description> tag specifies a textual description for the show and is populated by reading data from the Summary field of the Exhibitions table 30.

The <halllist> tag includes a plurality of <hall id> tags each specifying details of a hall within the show. The <halllist> tag is populated by querying the Halls table 32 (FIG. 7C) and populating a plurality of <hall id> tags with the results of the query. Specifically, each <hall id> tag is populated with the identifier of a hall, as well as a layout index (taken from the LiveMatrixPos field of the of the Halls table 32) and a hall number (taken from the HallNumber field of the Halls table 32).

The XML file of FIG. 18 further comprises an <assetlist> tag defining a plurality of files associated with the show. In this case the <assetlist> tag comprises a plurality of <asset id> tags each identifying a file associated with one of the halls identified by a <hall id> tag. Here it can be seen that there are three <asset id> tags each having an identifier corresponding to a hall identifier. Each <asset id> tag further specifies a file (in this case an XML file having a name which matches the hall identifier) and a checksum for that file. The use of checksums in embodiments of the invention is described in further detail below. However in the case of the XML files referred to in the <asset id> tags of FIG. 18, the checksum is not used, and is therefore set to a value of 0.

The XML file shown in FIG. 18 is received by the client application at step S15 and processed by the client application. It will be appreciated that the only information available to the client application is a name and description for the virtual exhibition, together with details of the virtual exhibition's constituent halls. The processing of the XML file results in the display of a hall map within the client application, as shown in FIG. 19. It can be seen that the hall map includes three boxes 82, 83, 84, one corresponding to each of the halls defined within the provided XML file. It should be noted that the positioning of boxes representing halls within the hall map is based upon the layout index specified within the <hall id> tags of the show XML file. The layout index takes a value in the range 0 to 99. The hall map is modelled as a grid having 100 positions, and the layout index determines which position should be taken by each hall. The 100 positions are shown in FIG. 20, with positions taken by the halls shown in the XML file of FIG. 18 being highlighted. In a case such as that shown in the XML file of FIG. 18 and the hall map of FIG. 19, given that only three halls are provided, the hall map is scaled to avoid white space.

FIG. 21 shows a hall map for a show having six halls, the six halls being arranged on the basis of the layout index values within an appropriate XML file. The layout index values included in the XML file are themselves obtained from the LiveMatrixPos field of the Halls table 32.

Each of the boxes in the hall maps of FIGS. 19 and 21 is selectable by a user to cause data relating to the relevant hall within the virtual exhibition to be downloaded. This involves processing the selection to obtain an XML file specified in the <asset id> tag associated with the selected hall. This processing involves requesting the XML file associated with the <asset id> tag from the database server 12. An extract from the XML file received in response to this request is shown in FIG. 22. It should be noted that the extract shown in FIG. 22 shows the general structure of the XML file. Lines which have been omitted are similar to those included in the extract shown in FIG. 22. “ . . . ” is used to indicate where lines have been omitted.

When the request for the appropriate XML file is received by the database server 12, the appropriate record of the Halls table 31 is queried to obtain data relating to the hall, and this data is assembled into the XML file provided to the client application. The appropriate record of the Halls table 31 is identified from the <asset id> tag in the halls XML file of FIG. 18 associated with the selection. The processing involves obtaining a name for the hall (taken from the Name field) which is used to populate a <name> tag. Two colours are also obtained by reading values from the LiveFloorColour and LiveBandColour fields, these colours being used to populate two <colour> tags within a <colours> tag. The <geometry id> tag within the XML file is used to indicate an identifier for the three dimensional data defining the hall. The value for the <geometry id> tag is obtained from the LiveMOID field of the Halls table.

The <boothlist> tag is used to define a plurality of booths within the hall. It can be seen that the <boothlist> tag comprises a plurality of <booth id> tags, each identifying a booth, providing its location in terms of an x-coordinate and z-coordinate position, providing an aisle identifier and providing its rotation. The <boothlist> tag is populated by searching the Booths table 33 for all booths having a LiveHID field which matches the currently processed record of the Halls table 31. Each identified booth results in the creation of a <booth id> tag. Each <booth id> tag is generated by storing the identifier of the booth taken from the BID field of the Booths table 33. The remainder of the <booth id> tag is populated by reading data from the LiveXpos, LiveZpos, LiveAisle and LiveRotation fields of the Booths table 33.

Each <booth id> tag has an associated <asset id> tag within an <asset list> tag included in the XML file of FIG. 22. Each <asset id> tag includes an identifier, a filename and a checksum. The <asset id> tags are populated by reading the MOID field from the appropriate record of the Booths table 33. The retrieved data is used to carry out a lookup operation in the ModelAssets table 35, resulting in retrieval of a value from the ASID field of an appropriate record. The value read from the ASID field is used to perform a lookup operation in the Assets table 36, and consequently to retrieve a filename and checksum (from the Filename and Checksum fields respectively) which are used to populate the <asset id> tag. It can be seen that each <booth id> tag has a corresponding <asset id> with the same identifier value.

The <asset list> tag does however additionally include tags for other assets associated with the hall for which data has been requested. Specifically, it can be seen that one <asset id> tag has an identifier of “40002562” and is associated with a file of type “.3DS”. This <asset id> tag provides three dimensional data defining the hall. Data to populate this <asset id> tag is obtained by carrying out a further lookup in the ModelAssets table 35, this time using the value of the MOID field of the appropriate record of the Halls table 32. One of the assets located by this lookup is the file having identifier 40002562 which is associated with the described <asset id> tag. Additionally, this look up operation yields a number of other results, as can be seen in FIG. 22. Each of these is a JPEG file which is used in combination with the three dimensional data defining the hall.

In general terms, from the preceding description of the XML files of FIGS. 18 and 22 it can be seen that different series of identifiers are used to identify different types of data associated with an exhibition. That is, for example, while identifiers of halls begin at “20000000”, identifiers of booths begin at “300000000” identifiers of three dimensional data files begin at “40000000” and identifiers of graphical data files begin at “5000000”.

Referring back to FIGS. 19 and 21, it was explained above that selection of a box representing a hall in one of those Figures results in the XML file of FIG. 22 being downloaded to the client application. Processing of the XML file of FIG. 22 by the client application is now described. The XML file is essentially parsed to identify relevant features of the hall to be displayed and the hall to be displayed in then rendered in the form of three-dimensional graphics. This process is described in further detail with reference to FIG. 23.

When the XML file is initially processed, an <asset id> associated with a three dimensional data file is identified at step S20. In the case of the XML file of FIG. 22, the <asset id> tag with identifier “40002562” is identified because this identifier is within the range of identifiers associated with three dimensional data files. The filename associated with the identified <asset id> tag is then obtained at step S21 and used to carry out a look up operation in the file store of the computer running the client application, at step S22. This lookup operation determines whether an appropriately named file is stored in a file store of the computer running the client application. If the file is not stored in the local file store, it is downloaded from the database server 12 at step S23, and then processed at step S26 as described below.

If the required file is located in the local file store, processing passes to step S24 where a check is carried out to determine whether a checksum value associated with the <asset id> tag matches a checksum value generated when an appropriate checksum algorithm is applied to the locally stored file. If this check is satisfied, it can be determined that the locally stored file is the same as that which is referred to in the XML file. If however the check is not satisfied it can be determined that the locally stored file is not the same as that which is referred to in the XML file. If the check of step S24 is satisfied, the locally stored file is read at step S25 and processed at step S26. If however the check of step S24 is not satisfied processing passes to step S23 where the appropriate file is downloaded from the database server 12.

It can be seen from the preceding description that the use of a checksum value within the <asset id> tags of the XML file provides a convenient mechanism for checking whether a local copy of a file is up to date. This allows previously stored data to be used when it is up to date, but ensures that updated data is downloaded when the previously stored data is out of date. In this way the competing goals of using up-to-date data and minimising unnecessary data traffic are effectively achieved.

Processing the three dimensional data file at step S26 involves standard graphical rendering operations being carried out. In preferred embodiments of the invention the client application uses DirectX to process the three-dimensional data file to generate the required three-dimensional image. Processing of the three-dimensional data file generates the graphics for the hall itself by generating and rendering appropriate polygons as is known in computer graphics processing systems. This rendering process will make use of various image files which are referred to in the three-dimensional data file.

In order to make the required image files available, <asset id> tags within the <assetlist> tag having identifiers within a predetermined range are identified and processed. Each appropriate <asset id> tag is located by use of identifier ranges as described above. At step S27 of FIG. 23 a check is made to determine whether there are further <asset id> tags to be processed. If it is determined that there are no further <asset id> tags to be processed it can be determined that all data required to render three-dimensional graphics for the hall is available such that the processing of step S26 can continue until the graphics are completely rendered. If however <asset id> tags remain which need to be processed, processing passes to step S28 where a filename associated with a particular <asset id> tag is obtained. At step S29 is check is made to determine whether the specified file is stored locally. If the file is not stored locally, processing continues at step S30 where the file is downloaded from the database server 12. Processing then returns to step S27. If however the check of step S29 determines that the required file is stored locally, processing passes from step S29 to step S31, where a checksum value in the <asset id> tag is compared with a checksum value associated with the locally stored copy of the file. If the compared checksum values match, processing passes to step S32 where the locally stored copy of the required file is loaded, before processing again returns to step S27. If however the compared checksum values do not match, processing passes to step S30, where the required file is downloaded from the database server 12.

The processing described thus far with reference to FIG. 23 results in the generation of graphics representing an exhibition hall. Such graphics may take a form similar to that illustrated in FIG. 24.

It can be seen from FIG. 24 that although the graphics for the hall itself is displayed, no booths or other exhibition artifacts are included in the graphical representation. Having generated graphics for the hall itself as shown in FIG. 24, the XML file of FIG. 22 is further processed to generate graphics representing booths within the exhibition. This processing is shown in the flowchart of FIG. 25. At step S35 a check is carried out to determine whether more booths are to be processed. If more booths are to be processed, processing continues at step S36 where an appropriate XML file defining the booth is requested. This request is generated by using the identifier of a booth identified within a <booth id> tag within the hall file of FIG. 22, and also with reference to the <asset id> tag corresponding to the appropriate <booth id> tag. This request will either involve reading an appropriate booth XML file from local storage or alternatively obtaining an appropriate booth XML file from the database server 12. Processing is carried out to determine whether the appropriate booth XML file is stored locally, and if the booth XML file is stored locally to determine whether its checksum matches that specified by the hall XML file of FIG. 22. This processing takes a similar form to that described above with reference to FIG. 23. The booth XML file takes the form shown in FIG. 26, and is received by the client application at step S37. Graphics representing the booth are then generated at step S38. It should be noted that FIG. 26 shows an extract from the XML file, although omitted lines take a form similar to those shown in FIG. 26. “ . . . ” is used to indicate where lines have been omitted.

Referring to FIG. 26, the generation of the XML file by the database server 12 using data stored in the database of FIG. 7 is described. A <booth version> tag is populated by locating an appropriate record of the Booths table 33 and reading data from the Version field. The MOB) field of the appropriate record of the Booths table 33 is read and used to populate a <geometry id> tag. The MOID field of the appropriate record of the Booths table 33 is also processed to identify an appropriate record of the Models table 34. Having identified an appropriate record of the Models table 34, data is read from the ModelType field which is used to populate a <modeltype> tag, and data is read from the Width and Depth fields to populate, respectively, a <width> tag and a <depth> tag.

Each booth has three associated colours: two wall colours and a floor colour. Values are read from the WallColour1, the Wall Colour2 and the FloorColour fields of the appropriate record of the Booths table 33 and these values are used to populate appropriate <colour> tags within the <colours> tag of the XML file of FIG. 26.

It can be seen that the XML file shown in FIG. 26 includes a <triggers> tag comprising a plurality of <slot link> tags. These represent hypertext links which are to be associated with slots included in a booth. The <slot link> tags are populated by carrying out a look up operation in the BoothSlots table 38 using the BID field value of the appropriate record of the Booths table 33. Values of the Link field of each identified record are then used to populate <slot link> tags.

As described above with reference to the XML file of FIG. 22, the XML file of FIG. 26 includes an <assetlist> tag which comprises a plurality of <asset id> tags identifying files which are associated with the booth represented by the XML file. It can be seen that each <asset id> tag includes an identifier, a filename and a checksum value. These tags are populated by identifying appropriate records of the Assets table 36 and reading appropriate data from those records.

The value of the MOID field of the appropriate record of the Booths table 33 is used to carry out a lookup operation in the ModelAssets table 35. This lookup operation locates a plurality of records of the Assets table 36 (by reference to the ASID field), and each of these assets is used to populate an appropriate <asset id> tag. This generates a plurality of <asset id> tags identifying assets associated with graphical data required to display the booth.

The value of the BID field of the appropriate record of the Booths table 33 is used to carry out a lookup operation in the BoothSlots table 38 as described above. Each record located by this lookup will include a value for its ASID field, and values of the ASID field obtained in this way can then be used to carry out a look up operation in the Assets table 36. Data obtained from the Assets table 36 in this way is then used to populate further <asset id> tags within the <assetlist> tag.

Referring back to FIG. 25, the XML file of FIG. 26 is received by the client application at step S37 and processed at step S38. This processing is now described. It is however to be borne in mind that this processing takes place after the hall XML file of FIG. 22 has been processed to generate graphics of the form shown in FIG. 24. It is also to be borne in mind that booth XML files of the type shown in FIG. 26 are downloaded based upon <booth id> and <asset id> tags within the hall XML file of FIG. 22, as described above.

Considering again the hall XML file of FIG. 22, it can be seen that <booth id> tag can be processed to obtain coordinates for each booth (specified by xpos and zpos values) as well as a rotation. Each <booth id> tag within the hall is processed to determine its location and rotation, and data within the corresponding booth XML file of the form shown in FIG. 26 is then used to generate appropriate graphical data. Specifically, for each booth the three dimensional data identified by the <geometry id> tag and by an appropriate <asset id> is obtained and rendered to create a representation of the booth. This involves obtaining images specified within <asset tags> in the booth XML file, and adding such images to the rendered graphics. It will be appreciated that the three dimensional data and images required to generate graphics representing a booth will typically be downloaded from the database server 12. However the checksum value associated with each <asset id> tag of the booth XML file can be used as described above so as to allow locally stored data to be used if that data is up to date, while forcing data to be downloaded when the locally stored data is not up to date. Generation of booths also involves the association of hypertext links with slots of the booth, such that a user can select a particular image and be presented with a webpage pertinent to that image.

It will be appreciated that the generation of graphical data as described above will need to make use of various techniques which are known in computer graphics processing. In particular it is necessary to select a viewpoint (also referred to as a camera position) from which the graphics are to be “seen” and to generate graphics based upon this view point. In general terms the graphical data is stored in the form of an octree and a view volume is projected onto the octree so as to obtain graphical data representing the parts of a virtual world visible from the view point.

It will be appreciated that the display of a large number of booths, each including a large number of slots, will require much data to be downloaded. Much of this data will take the form of image files which are used to populate slots within a booth. In order to allow an exhibition to be displayed even when all data has not been downloaded, exhibitions can be displayed in stages. Specifically, exhibitions are initially rendered using standard slot images which simply include numbers corresponding the reference number of each slot. The images are then downloaded in a particular order so as to create a complete graphical representation of each booth. It should be noted that initially a user's view point is known. It therefore follows that the distance from the view point to each image required to generate the scene can be determined. Images are downloaded based upon the distance from the user's view point. This is now described with reference to FIG. 27.

Referring to FIG. 27, a camera position Cₚ is shown as are four images P₁, P₂, P₃, P₄ within a graphical scene. V_{c} is a vector of unit length indicating the direction of the camera's view. Fₐ and F_{b} are vectors defining the bounds of a view frustum defined by the camera.

Vectors Vp₃ and Vp₄ are respectively vectors between the camera position Cₚ and the images P₃ and P₄. It should be noted that the images P₃ and P₄ will take the form of three dimensional volumes, and calculations based upon their positions are therefore carried out with reference to their midpoints. Similar vectors Vp₁ and Vp₂ can be defined, although these are not shown in FIG. 27.

Vectors and positions such as those shown in FIG. 27 are processed so as to determine the order in which the required images should be downloaded or otherwise loaded from the local file store.

It can be seen from FIG. 27 that:

V_{c}·Vp₃=|V_{c}∥Vp₃| cos θ

where |X| is the magnitude of vector X.

Given that |V_{c}|=1, equation (1) above can be rearranged to give:

$$\frac{{V}_{c} \cdot {Vp}_{3}}{\vert {Vp}_{3} \vert} = cos θ \qquad ( 2 )$$

It can be determined that if

$$\frac{{V}_{c} \cdot {Vp}_{3}}{\vert {Vp}_{3} \vert} < Vc \cdot {F}_{b} \qquad ( 3 )$$

The image P₃ is outside the view frustum and can therefore be ignored. Otherwise, the image P₃ is within the view frustum, as is the case in the example of FIG. 27.

By processing vectors between each image and the camera position Cₚ images to be discarded from the scene can be determined.

Additionally, the value of

$$Priority = \frac{1}{cos θ} \vert {Vp}_{n} \vert \qquad ( 4 )$$

can be used to prioritise the processing of required images, where Vpₙ is the vector between the camera position Cₚ and an image n.

Substituting equation (2) into equation (4) gives:

$$Priority = \frac{1}{\frac{{V}_{c} \cdot {Vp}_{n}}{\vert {Vp}_{n} \vert}} \vert {Vp}_{n} \vert \qquad ( 5 )$$

It can also be noted that equation (5) can be rewritten as:

$$Priority = \frac{\vert {Vp}_{n} \vert}{{V}_{c} \cdot {Vp}_{n}} \vert {Vp}_{n} \vert \qquad ( 6 )$$

That is, the priority for each image n can be determined and images with a relatively high priority value can be downloaded and added to the scene before images with relatively low priority values.

It should further be noted that equation (6) can be rewritten as:

$$Priority = \frac{{\vert {Vp}_{n} \vert}^{2}}{{V}_{c} \cdot {Vp}_{n}} \qquad ( 7 )$$

In preferred embodiments of the present invention equation (7) is used to prioritise images to be downloaded and processed, as it avoids the need to calculate a square root, which is computationally expensive.

From the preceding description of FIG. 27 it can be seen that the vector calculations described above allow the order in which images are processed to be prioritized based upon their vector distance from a stationary camera position. In this way, images which are relatively proximate to a camera position and therefore relatively prominent to a user are downloaded and added to the graphical scene before images which are relatively distant and non-prominent. Prominence is taken into account in the calculations set out above with reference to angle relative to the view angle of the camera. In this way a method is provided in which a meaningful graphical image is built up. That is, even when images have not yet been downloaded and/or applied to the graphical scene a version of the scene is displayed to the user, and the scene is enhanced as more data is obtained. In this way, even if a relatively low bandwidth connection is provided between the client application and the database server 12, this is still sufficient to allow the required graphical data to be obtained and processed.

It should additionally be noted that the processing described above with reference to FIG. 27 is preferably carried out only when the camera position (or view point) is stationary. That is, while the camera position is moving, processing concentrates on providing smoothly moving graphics without the overhead of downloading and processing required images. When the camera position is stationary, the processing described above is carried out.

Having downloaded and processed data representing an exhibition in the manner described above, a graphical representation of the exhibition is presented to the user, and the user is able to navigate around the graphical representation using a suitable input device such as a keyboard or a pointing device such as a mouse. A screenshot of a hall comprising a number of booths around which a user can navigate is shown in FIG. 28.

It can be seen from FIG. 28 that the client application provides a number of buttons arranged on a button bar 90. A home button 91 causes a predetermined home page associated with the client application to be displayed in the web browser. A back button 92 effectively undoes a previous selection. A show list button 93 causes a list of shows for which the user holds tickets to be displayed in the area 80, as shown in FIG. 28 and as described above. A halls layout map button 94 causes a map of halls within a show to be displayed. This map of halls takes the form shown in FIGS. 19 and 21 which have been described above.

A booths layout map button 95 causes a map of booths within the hall currently being displayed within the area 81 to be displayed. This is shown in FIG. 29, where it can be seen that a booths layout map is displayed in a window 100 which is overlaid on the area 81. It can be seen that each booth included within the hall is represented by a respective rectangle. It can further be seen that an indicator 101 indicates a current camera position within the hall. A user is able to navigate around the booths layout map in the window 100, and the graphics displayed in the area 81 will vary accordingly. Rectangles in the booths layout map can be selected to cause the graphical display in the area 81 to show the portion of the hall adjacent the selected booth. It can be seen that rectangles in the booths layout map are marked with aisle and booth numbers associated with respective booths. This information is taken from the hall XML file shown in FIG. 22.

It can be seen from FIG. 30 that the area 81 includes an exhibition booth with an information icon 102. Selection of this information icon 102 causes an exhibitor profile to be displayed in the area 80. The exhibitor profile is obtained from the database server 12 and the database shown in FIG. 7, by requesting appropriate data from the Booths table 33. This includes name and contact information used to populate the exhibitor profile displayed in the area 80. Additionally, data is obtained from the Products table 42 and used to provide a list of products associated with the exhibitor.

It can be seen that the exhibitor profile additionally comprises four buttons 103, marked “Audio” 103a, “Brochure” 103b, “Video” 103c and “Add to Favorites” 103d. The “Audio”, “Brochure” and “Video” buttons are all configured to provide appropriate information which is downloaded from a remote server. The location of the information to be downloaded in response to selection of the buttons is respectively taken from the AudioLink, CatalogueLink and VideoLink fields of the Booths table 33. The “Add to Favorites” button 103d is used to add details of a particular exhibitor to a user's favorite exhibitors, and a list of such favorite exhibitors can then be retrieved as discussed below. Additionally, it can be seen that the exhibitor profile provides links allowing an email to be sent, an appropriate website to be visited and a business card to be left. Again, the action taken by selection of these links is determined by obtaining data from the database shown in FIG. 7.

Referring back to FIG. 28 it can be seen that the button bar 90 includes a favorites button 96. Selection of the favorites button 96 causes the area 80 to display details of the user's favorite booths as shown in FIG. 31. It can be seen that a list comprising a plurality of entries 104 is provided. Each entry identifies an exhibitor and provides details of the location of their booth in terms of a hall and booth number 105. Each entry can be deleted by selecting a respective delete option 106. The user's entire list of favorites can be deleted by selection of a Delete All button 107. The user's favorites can be exported to an appropriate CSV file by selection of an export button 108, thus allowing the user to sort and otherwise manipulate details of their favorite exhibitors. It can be seen that the area 80 is configured to allow a plurality of pages of favorite exhibitors to be provided, with an indication 109 providing details of a currently displayed page, and links 110 allowing a user to select which page should be displayed. From FIG. 31 and its associated description it can be seen that a mechanism is provided in which a user can collate details of favorite exhibitors for convenient future reference.

It should be noted that each entry 104 is selectable by a user to cause an exhibitor profile associated with that entry to be displayed in the area 80. The displayed exhibitor profile takes the form described above with reference to FIG. 30.

Referring back to FIG. 28, selection of an A to Z button 97 causes the client application to present an A to Z list of exhibitors, as shown in FIG. 32. It can be seen that the list is presented in the area 81, while the area 80 provides facilities to search and sort the presented list. It will be appreciated that this information is generated by querying the database shown in FIG. 7. Additionally, it should be noted that entries in the A to Z list are selectable to cause display of an exhibitor profile, as described above with reference to FIG. 30.

Referring back to FIG. 28, it can be seen that the button bar 90 further comprises a help button 98 causing appropriate help information to be displayed, and a print button 99 causing the contents of the area 80 to be printed.

It can be seen from figures showing the client application that a menu bar is provided with various functions. These are now briefly described. A File menu provides options to login and logout, as well as options to display a home page in a web browser and exit the client application. A View menu provides options to toggle the display of the button bar 90 a status bar and the area 80. The hall map (as shown in FIGS. 19 and 21) and the booths layout map (as shown in FIG. 29) can also be displayed by selecting appropriate menu options from the View menu.

A Tools menu allows an options dialog to be displayed, as shown in FIGS. 33A and 33B. It can be seen that the options dialog includes a first tab shown in FIG. 33A which allows graphics options to be specified. Specifically, details of a renderer to be used to generate graphics data can be specified, and an indication of graphics quality can be specified using a slider bar. The options dialog includes a second tab shown in FIG. 33B. It can be seen that this tab is simply concerned with configuring operation of a mouse which is used to navigate through the presented graphical scene.

The Tools menu further comprises a search option allowing an exhibitor search to be carried out, an A-Z listing option allowing an A-Z list of the type shown in FIG. 32 to be displayed and a clear offline content option allowing cached data to be deleted.

A Help menu provides various help functions in an essentially conventional manner.

The preceding description of the client application has been concerned with the use of the client application to allow a user to buy tickets and navigate through an exhibition. Use of the client application (together with the web browser) to allow an exhibitor to configure an exhibition booth is now described. Referring back to FIG. 8, it can be seen that the presented webpage includes the Exhibitors button 56 mentioned above. In order to exhibit at an exhibition this button is selected. This causes the display of the webpage shown in FIG. 34. This webpage presents as a flowchart the process of exhibiting at an exhibition. It can be seen that steps S1, S2, and S3 relating to registration, downloading of the client application, and visiting a demo show are as described above with reference to FIG. 9. Step S4 is also analogous to step S4 of FIG. 9, where a show is selected using a webpage as shown in FIG. 11, although here a show in which to exhibit, rather than to visit is selected.

Having selected a show, an exhibitor completes an exhibition agreement form at step S50. This takes the form shown in FIG. 35. Much of the detail included in the form can be taken from data already stored in the database shown in FIG. 7. In particular, the registration process with have established a record in the Registrants table 39 which can be queried to read name and address details. A user completing the webpage of FIG. 35 does however select modes of trade in an area 110, enters brands in an area 111 and company information in an area 112. Additionally products which are to be offered on an exhibitors booth are selected in areas 113, 114. The areas 113, 114 provide selectable lists which are populated by reading data from the Products table 42, the records being identified by carrying out a lookup operation in the ExhibitionProducts table 45. A user can enter additional products which are not listed in the areas 113, 114 in a free text area 115.

It should be noted that data entered using the webpage of FIG. 35 is used to populate an appropriate record of the Booths table 33. In particular, the contact information, mode of trade information, brand information and company information is used to populate the appropriate record. Additionally, appropriate records are created in the BoothProducts table 44 allowing product details in the areas 113, 114 to be associated with a booth.

The webpage of FIG. 35 additionally allows a user to specify their type of booth using a drop down list 116. Typically an exhibitor will be able to select between a plurality of predefined booth sizes and layouts, and a desired size and layout can be selected using the drop down list 116. Details of available booth sizes and layouts can be presented to a user using a booth catalogue, extracts of which are shown in FIGS. 36A and 36B. It can be seen that for each booth a number of slots provided is shown, together with details of image sizes which are associated with those slots.

Referring back to FIG. 35, the webpage provides a set of radio buttons which are usable to indicate the nature of the exhibitor's listing in an A to Z listing of the type described above. Specifically, the prominence of the entry and whether it is to include a logo can be specified. An area 118 indicates details of terms and conditions to which an exhibitor agrees, and allows an Apply Now button 118 to be used to complete the application procedure. It is to be noted that completion and submission of the web page of FIG. 35 results in the creation of a record in the Booths table 33 of the database of FIG. 7.

Referring back to FIG. 34, it can be seen that after completing the exhibition agreement form at step S50, a user proceeds to build a booth at step S51 and then to exhibit in an exhibition at step S52.

FIG. 37 shows the process for applying for a booth and exhibiting in further detail. At step S60 a user applies for a booth using the webpage of FIG. 35 as described. When the application is submitted, an exhibition administrator is informed by email at step S61, allowing the application to be processed at step S62. The processing may involve manual and/or automated processing of provided details. Payment is requested from the exhibitor and processed by the exhibition administrator at step S63. When payment has been received the application is approved at step S64, and the exhibitor is informed by email at step S65. The booth can then be built at step S51 as described above. When built, the booth is accepted by the exhibition administrator at step S67, before being exhibited at step S52.

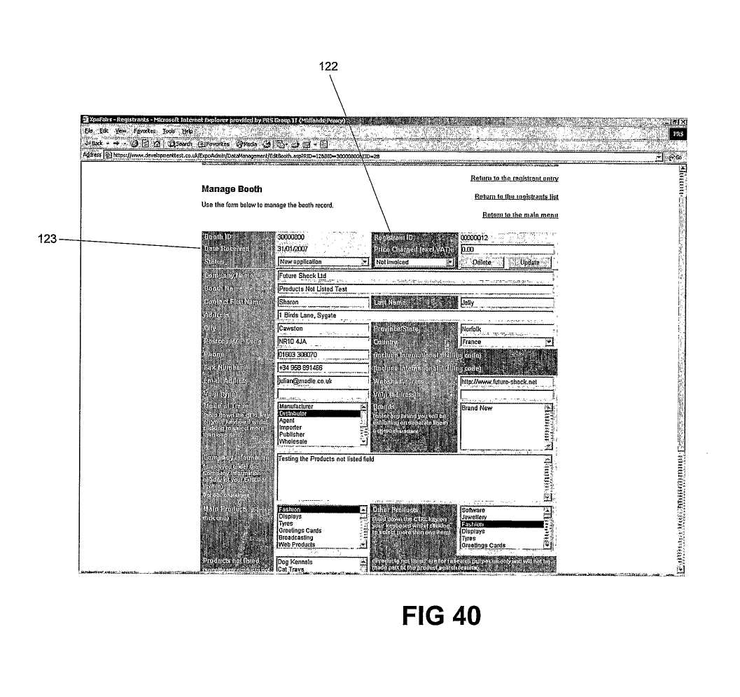

FIGS. 38 to 40 show web pages presented to an exhibition administrator to allow processing described above to be carried out. When an exhibition administrator logs on to a website providing the web pages of FIGS. 38 to 40, he is presented with details of a plurality of exhibitors who have applied for booths. Each application can be managed by selecting a Manage button 120. This results in the display of the web page shown in FIG. 39. This webpage presents details of the exhibitor (not shown) together with details of all booths which the exhibitor has requested with an associated status. It can be seen that the booths include a booth having a status of new application. This booth can be managed by selecting a Manage button 121 which causes the display of the web page of FIG. 40. The web page of FIG. 40 presents details of a particular booth application, and allows an exhibition administrator to use an area 122 to indicate a payment status, and an area 123 to indicate an application status. The area 123 is used to indicate approval of a booth application. Data entered using the web page of FIG. 40 is used to update the appropriate record of the Booths table 33.

A user makes use of the client application described above to create a booth. The user logs on using the interface of FIG. 15. If the user is an exhibitor, the Admin menu provides a Booth Creation option which a user selects to configure their booth. Selection of the Booth Creation option causes the display of the screen shown in FIG. 41. In general terms it can be seen that the area 80 presents a user interface configured to allow booth configuration, while the area 81 provides a graphical representation of the booth as it currently exists.

In more detail, the area 80 includes a list 125 of booths associated with an exhibitor. These booths can be in a variety of states. For example some booths will have been applied for but are waiting approval. Others will have been accepted such they appear in live exhibitions and can no longer be changed by an exhibitor. Others however will have been approved and are ready to be configured by the exhibitor. One such booth is selected in the list 125.

It can be seen that the area 81 provides a graphical preview of the booth. Data is displayed in the area 81 in response to selection of a Save and Preview button 126 in the area 80. When the Save and Preview button 126 is selected an XML file representing the appropriate booth (identified from data in the list 125) is downloaded and processed to create the graphical preview. This downloading and processing takes a form similar to that described above with reference to the creation of graphics representing an exhibition. In particular, it is to be noted that images are, where appropriate downloaded to populate slots within the booth.

The area 80 provides a user with an ability to add images to the various slots of the booth. It can be seen that a drop down list 127 allows an image slot to be selected. When one of the slots is selected its size data is displayed in an area 128. To aid the booth configuration process, slots are initially displayed showing their slot numbers, thus helping a user to identify how slots are positioned within a booth. The number of slots associated with a booth (which is used to populate the drop down list 127) is determined by determining a model on which the booth is based (with reference to a value of the MOID field of the Booths table 33), and locating a plurality of records of the Slots table 37 based upon the value of the MOID field. Each record of the Slots table 37 located in this way has associated size and width data, and such data is displayed in the area 128.

When a slot to be populated is selected using the drop down list 127, a user uses a browse button 129 to cause the display of a file system window allowing an appropriate graphics file to be located. When an appropriate file is selected, its filename is displayed in a text box 130. A text box 131 is configured to receive details of a link which is to be associated with the slot identified in the drop down list 127 such that selection of that slot when the booth is included in an exhibition will cause a webpage associated with the link to be displayed. Data representing the link input to the text box 131 and data representing the file identified in the text box 130 are uploaded to the database server 12, where they are used to populate an appropriate record of the BoothSlots table 38.

By selecting each slot of the booth in turn using the drop down list 127, a user can associate images with each slot of the booth. At any time during the process of adding images, the Save and Preview button 126 can be selected. This causes the uploading of data mentioned above. It also cases the download of an XML file representing the booth, which is used to update the graphical data displayed in the area 81.

It can be seen that the area 80 further comprises an area 132 usable to select colours associated with a booth. Selecting a box in the area 132 causes the display of a palette of colours from which a user can select. Data representing selected colours is then uploaded to the database server 12 and used to populate an appropriate record of the Booths table 33.

An area 133 of the area 80 provides text boxes into which a user can enter links associated with video, audio and brochure content. These links are used to appropriately configure exhibitor details as shown in FIG. 30.

A submit button 134 is also provided. This button is selected by a user when booth configuration is complete, and the user is ready to submit the booth for inclusion in the exhibition (subject to exhibition administrator acceptance).

Thus, it can be seen from FIG. 41 that a convenient mechanism is provided to allow booths to be created and previewed in real time. The mechanism is such that users obtain real time feedback as to the look and feel of their booth, thus aiding the booth configuration process.

Referring back to FIG. 36, it can be seen that when booth building is complete at step S66, a booth then needs to be accepted by an exhibition administrator. This is again achieved using the client application described above, although on this occasion and exhibition administrator logs on with an appropriate user name and password. When a user logs on in this way it is possible to select a Booth Review option from the provided Admin menu, causing the screen shown in FIG. 42 to be displayed. It can be seen that the area 80 includes a list 135 of booths which are to be reviewed. When a booth is selected from the list 135 a Preview button 136 is selected to cause the selected booth to be displayed in the area 81. An exhibition administrator can then ensure that the previewed booth satisfies any requirements. For example the exhibition administrator may ensure that all images comply with appropriate dimension requirements, and may additionally ensure that the content of all images is appropriate to the exhibition's audience. For example, the exhibition administrator may ensure that no adult content is included within a booth if the exhibition is to be accessed by children. A drop down list 137 is used to indicate the result of the exhibition administrator's review, and the result is stored in the database by selection of a Submit button 138. If a booth is not approved, a reason for non-approval may be entered in a text box 139. Data submitted using the area 80 in FIG. 42 is used to appropriately update the Booths table 33 in the database.

The preceding description has been concerned with the configuration of booths having one of a plurality of standard forms. In some embodiments of the present invention booths are not restricted to taking one of such forms but can instead take the form of bespoke booths which are created by a user. Such booths can be created initially, and then configured using configuration methods such as those described above. Such booths are preferably represented by appropriate XML files, thus allowing bespoke booths to be processed in the same way as booths having a standard form. In some embodiments of the invention, a user requests creation of a bespoke booth and is then provided with a “shell” similar to that associated with a booth having a standard form. The user can then configure their bespoke booth in the manner described above.

In addition to the functionality described above, it should be noted that the client application also provides an exhibition administrator with the ability to configure exhibition halls, and place booths within those halls. This is now described with reference to FIGS. 43 and 44.

Referring first to FIG. 43 It can be seen that the area 80 provides an interface allowing details of halls within an exhibition to be configured. It can be seen that a drop down box 140 allows an exhibition to be selected. A list of halls within that exhibition is displayed in an area 141. The area 141 is initially populated with a maximum number of halls within an exhibition, all marked “unused”. One of the displayed halls can be selected for configuration. It can be seen that halls denoted “HALL 1”, “HALL 2” and “HALL 3” in FIG. 43 have already been so configured. When a hall is selected in the area 141 its name can be entered in a text box 142. A drop down list 143 can be used to select a hall style, and this corresponds to a graphical model upon which the geometry of the hall is to be based. A check box 144 is used to indicate whether the currently configured hall is active (i.e. whether it appears in the exhibition to which it relates.

A drop down list 145 is used to set a matrix position for a hall. This matrix position determines a position for the hall within a hall map, as described above. A drop down list 146 is used to specify a number for the hall, which number is used to identify the hall more easily to visitors and exhibitors. Boxes 147, 148 are selectable to cause a palette of colours to be defined, and colours can then be selected from the palette to specify floor and band colour for the configured hall. The selected band colour determines the colour of box used to represent the hall in a hall map of the type shown in FIGS. 19 and 21.

When configuration of a particular hall is complete, a user selects a Submit button 149 to cause the input data to be uploaded to the database server 12, where it is used to update the Halls table 32.

A webpage is provided to configure various parameters associated with a show, and this is shown in FIG. 43A. It can be seen that this webpage provides various fields into which a user can enter data relating to a show. This data configures both webpages associated with the show, and the way in which the show appears in the client application. It should also be noted that the webpage provides an Update & Sync button 149a which is selectable by a user to cause changes made to a show to be reflected in that show as presented to a visitor. Such changes include changes made using the webpage of FIG. 43A as well as changes made using the client application. For example, when a hall is configured as described above with reference to FIG. 43, its configuration is only reflected in the show as seen by a visitor after the Update & Sync button 149a has been selected. Similarly, when booths are positioned in a hall as described below, their positioning takes effect in a show as seen by a visitor only after the Update & Sync button 149a has been selected.

Referring to FIG. 44, an interface for allowing an exhibition administrator to position booths within an exhibition is shown. It can be seen that an exhibition is selected using a drop down list 150. When an exhibition is selected from the drop down list 150, an appropriate booth within that exhibition can then be selected from a list 151. Booths appearing in the list can be filtered using a drop down list 152 so that only, for example, booths which are yet to be positioned can be seen, or alternatively only booths awaiting removal can be seen.

When a booth is selected in the list 151, its dimensions are displayed in an area 153. A dropdown list 154 is used to select a hall in which the booth is to be placed, and a preview button 155 is used to cause the display of graphics representing that hall in the area 81.

An area 156 is used to specify location, orientation and aisle data for a particular booth. Data input to the area 156 is submitted to the database and used to populate the Booths table 33 when a Submit button 157 is selected.

It has been described above that exhibitions are made up of a plurality of halls. In preferred embodiments of the invention a graphical representation of an exhibition hall in the area 81 of the client application includes an area which is selectable by a user to cause the user to move to another exhibition hall. This is shown in FIG. 45, where it can be seen that an arrow 160 is selectable by a user to cause movement into another exhibition hall. The breaking down of an exhibition into a plurality of halls in this way in a convenient mechanism of limiting the quantity of data associated with a particular hall, and therefore making data transfer and processing requirements more manageable.

It has been described above that booths can either be created based upon one of a plurality of standard forms or can alternatively be so-called bespoke booths. In either case it will be appreciated that there is a need for a method of uploading data defining booths. FIG. 46A is a screenshot of a user interface allowing booth definitions to be uploaded.

It can be seen that a list 165 shows currently uploaded booths. An entry in the list 165 can be selected, and then a Delete button 166 can be used to cause its deletion. A New button 167 is used to add new booths to the database. It can be seen that a drop down list 168 is used to specify the type of data which is to be uploaded. This will be set to a value of “Booth” when a standard booth is being uploaded and a value of “Bespoke Booth” when a bespoke booth is being uploaded. Other values can also be used as described below.

Having selected that data defining a booth is to be uploaded an Enabled check box 169 is used to indicate whether the uploaded data is to be enabled for use. Text boxes 170, 171 are used to indicate booth width and depth, while a text box 172 is used to indicate a number of slots associated with the booth. A name can be specified in a text box 173. A text box 174 is used to receive a filename of a file specifying three dimensional graphics for the booth. The text box 174 can be populated using a Browse button 175 which causes a file system dialog to be displayed allowing a user to select a desired file. A text box 176 is used to specify textures which are to be applied to the three dimensional graphics specified by the file identified in the text box 174. Again, a Browse button 177 is usable to cause a file system dialog to be displayed allowing user selection of an appropriate file whose name is to be entered in the text box 176. In this context it should be borne in mind that the term “texture” is used to indicate any image which is overlaid on the three dimensional graphics data. Thus while a texture may provide a particular textured finish, it may alternatively apply an image to a part of the three dimensional graphics.

Files added using the text boxes 174, 176 are displayed in a list in an area 178. It should be noted that a file identified in the textbox 174 is added to the area 178 only upon selection of a submit button 179. In contrast, files identified in the textbox 176 are added to the area 178 automatically when they are entered in the textbox 176. In this case, the submit button 179 is only used to transmit details of files to the database server 12.

A drop down list 180 and two text boxes 181, 182 are used to specify a maximum image size. Specifically, the dropdown list 180 is used to select a particular slot, while textboxes 182, 183 are used to specify a maximum image size associated with that slot.

FIG. 46B shows the screen of FIG. 46A in which the area 178 is populated. It can be seen that a plurality of JPEG files are included in the area 178 each having an associated type and action. The type indicates either that the file represented by line of the area 178 is a geometry file or alternatively indicates that the file is a private file, or a file that is shared once or shared many times. The action associated with a file indicates the action that will be carried out when the submit button is selected. The interface is configured so as to allow a texture which is currently shared to be made private and vice versa. Similarly, if a texture is to be deleted the interface is able to manage that deletion so as to ensure that other booths are not adversely affected.

When a booth has been specified using the interface shown in FIG. 46 it is uploaded when a Submit button 179 is selected as described above. It should be noted that this uploaded will involve the creation of a new record in the Booths table 33, the Models table 34 and the Assets table 36 (FIG. 7).

The description of FIGS. 46A and 46B presented above has been concerned with the specification of booths. It should be noted that the same interface is usable to upload graphical data defining other parts of a virtual exhibition, if the drop down list 168 is appropriately used. For example graphical data defining aisle indicators and signage can be specified in this way, and then placed within an exhibition hall.

Embodiments of the invention described above have been concerned with the provision of virtual exhibitions. It will be appreciated that features of the invention can be applied in any three dimensional environment provided in a computer system. For example, instead of representing a virtual exhibition the three-dimensional environment may represent a retail environment around which a user is able to navigate and select products for purchase. Similarly, the three-dimensional environment may represent a museum which a user is able to visit by navigating around a virtual world and viewing various exhibits.

Although preferred embodiments of the invention have been described above, it will be appreciated that modifications can be made to those embodiments without departing from the spirit and scope of the present invention, as defined by the appended claims.

1-100. (canceled)

101. A method for displaying a graphical representation of a scene in a computer system, the method comprising:
displaying a first graphical representation of said scene;
receiving user input identifying graphical data to be applied to at least one of a plurality of surfaces of said scene; and
displaying a second graphical representation of said scene in which said graphical data is applied to said at least one of said plurality of surfaces.

102. A method according to claim 1, wherein each of said plurality of surfaces has an associated identifier.

103. A method according to claim 2, wherein said first graphical representation of said scene displays identifiers associated with each of said plurality of surfaces.

104. A method according to claim 1, wherein said user input identifying graphical data to be applied to said at least one of said plurality of surfaces comprises data identifying a file storing said graphical data.

105. A method according to claim 1, wherein receiving user input comprises:
presenting a user interface configured to receive user input identifying graphical data to be applied to said at least one of said plurality of surfaces.

106. A method according to claim 5, wherein said user interface is configured to receive an identifier of said at least one of said plurality of surfaces to which said graphical data is to be applied.

107. A method according to claim 1, further comprising:
receiving user input identifying navigation data to be associated with at least one of said plurality of surfaces; and
storing said navigation data in association with said at least one of said plurality of surfaces.

108. A method according to claim 1, wherein displaying said first graphical representation of said scene comprises receiving data defining said scene from a remote server.

109. A method according to claim 8, wherein said data defining said scene comprises a data file identifying a plurality of data items required to display said first representation of said scene.

110. A method according to claim 9, further comprising:
processing said data identifying said plurality of data items required to display said first representation of said scene to determine whether each of said plurality of data items is available locally;
if one of said plurality of data items is available locally obtaining said data item from local storage; and
if one of said plurality of data items is not available locally downloading said data item from a remote server.

111. A method according to claim 10, wherein obtaining said data item from local storage comprises:
processing said data identifying said plurality of data items required to display said first representation of said scene to determine a first parameter value associated with said data item;
processing said data item obtained from local storage to determine a second parameter value associated with said data item obtained from local storage;
comparing said first and second parameter values; and
if said comparing indicates that said first and second parameter values do not satisfy a predetermined criterion, downloading said data item from a remote server.

112. A method according to claim 9, wherein at least one of said data items comprises a three dimensional definition of said scene.

113. A method according to claim 9, wherein at least one of said data items comprises graphical data to be applied to a surface in said scene.

114. A method according to claim 9, wherein said data identifying a plurality of data items required to display said first representation of said scene is defined by a file of predetermined format.

115. A method according to claim 1, further comprising uploading said data identifying graphical data to be applied to said at least one of said plurality of surfaces of said scene to a remote server.

116. A method according to claim 14, wherein displaying said second graphical representation of said scene comprises receiving data defining said scene from a remote server, said data including reference to said graphical data to be applied to said at least one of said plurality of surfaces.

117. A method according to claim 16, wherein said data defining said scene comprises data identifying a plurality of data items required to display said second representation of said scene.

118. A method according to claim 1, further comprising providing a user interface, said user interface being configured to allow a user navigate around at least one of said first graphical representation of said scene and said second representation of said scene.

119. A method according to claim 18, wherein said user interface is configured to allow a user to navigate around said first representation of said scene and said second representation of said scene.

120. A method according to claim 1, further comprising:
receiving user specification of at least one colour; and
applying said specified colour to a part of said second graphical representation of said scene.

121. A method according to claim 1, further comprising receiving user input defining a hyper link to be associated with said scene.

122. A method according to claim 1, wherein said scene comprises an exhibition space.

123. A method according to claim 22, wherein said scene comprises an exhibition booth.

124. A method according to claim 22, wherein said plurality of surfaces each comprise a surface of said exhibition space intended to be associated with an image.

125. A method for creating a graphical representation of an exhibition booth for inclusion in a virtual exhibition, the method comprising:
displaying a first graphical representation of said exhibition booth;
receiving user input identifying graphical data to be applied to at least one of a plurality of surfaces of said exhibition booth; and
displaying a second graphical representation of said exhibition booth in which said graphical data is applied to said at least one of said plurality of surfaces.

126. A method for generating a graphical representation of a scene in a computer system, the method comprising:
determining a plurality of data items required to generate said graphical representation of said scene;
for each of said data items, determining a point in said scene associated with the data item;
determining a view point position in said scene;
processing said points associated with said data items and said view point to generate data indicating an order in which said data items should be processed; and
processing said data items in said order.

127. A method according to claim 26, wherein each of said data items is an image to be applied to a surface in said scene, and said images are applied to said surfaces in said order.

128. A method according to claim 26, wherein said order is based upon a prominence of said data items in said scene based upon said view point.

129. A method according to claim 26, wherein each of said data items is stored at a remote server, and said data items are downloaded in said order.

130. A method according to claim 26, wherein said processing to generate said order takes into account a distance between said view point and said points associated with said data items.

131. A method according to claim 26, wherein said processing to generate data indicating said order takes into account an angle between a view vector and vectors between said view point and each of said points associated with said data items.

132. A method according to claim 26, further comprising:
displaying an alternative data item pending processing of a data item associated with a point in said scene.

133. A method according to claim 26, further comprising:
receiving data indicating movement of said view point; and
deferring processing until said view point is stationary.

134. A method according to claim 26, wherein said scene represents a virtual exhibition.

135. A method according to claim 34, wherein said virtual exhibition comprises a plurality of booths, and at least some of said data items are associated with said booths.

136. A method according to claim 35, wherein said data items are advertising images associated with said booths.

137. A method for generating a graphical representation of a scene in a computer system, the method comprising:
determining a plurality of data items to be downloaded from a remote data source to generate said scene;
for each of said data items, determining a point in said scene associated with the data item;
determining a view point position in said scene;
processing said points associated with said data items and said view point to generate data indicating an order in which said data items should be downloaded
downloading said data items from said remote data source in said order.

138. A method of hierarchically storing data defining a scene to be displayed graphically in a computer system, the method comprising:
storing in a first file details of a plurality of objects in said scene; and
storing in respective second files data relating to each of said objects;
wherein said first file references each of said second files, and said first file and each of said second files references further files comprising graphical data defining said scene.

139. A method of providing a plurality of virtual exhibitions in a computer system, the method comprising:
storing data defining said plurality of virtual exhibitions;
providing a first user interface, said first user interface being configured to receive user input comprising requests to exhibit at a specified one of said virtual exhibitions; and
providing a second user interface, said second user interface being configured to receive user input comprising requests to view a specified one of said virtual exhibitions.

140. A method of providing a plurality of virtual exhibitions, the method comprising:
storing data defining each of said plurality of virtual exhibitions, each virtual exhibition having associated graphical data;
storing data defining each of a plurality of users;
receiving a user request, said request identifying one of said plurality of users, and indicating one of said plurality of virtual exhibitions;
in response to said user request, generating a ticket, said ticket being associated with said one of said plurality of users and said one of said virtual exhibitions; and
restricting access to each of said virtual exhibitions to users having tickets associated with the respective virtual exhibition.

141. A computer readable medium carrying computer readable code configured to control a computer to carry out a method according to claim 1.
